(19) United States
(12) Patent Application Publication
(10) Pub. No.: US 2025/0322510 A1
(43) Pub. Date: Oct. 16, 2025

(54) NEURAL NETWORK-BASED ULTRASOUND IMAGE PREDICTION AND COMPOUNDING

(71) Applicant: GE Precision Healthcare LLC, Waukesha, WI (US)

(72) Inventors: Sushanth Govinahallisathyanarayana, Bengaluru (IN); Gurunath Reddy Madhumani, Bengaluru (IN); Chandan Kumar Mallappa Aladahalli, Bengaluru (IN)

(21) Appl. No.: 18/775,096

(22) Filed: Jul. 17, 2024

(30) Foreign Application Priority Data
Apr. 10, 2024 (IN) 202441029030

(51) Int. Cl. G06T 7/00

(52) U.S. Cl. CPC G06T 7/0012; G06T 2207/10132; G06T 2207/20081; G06T 2207/20084

(57) ABSTRACT

One or more systems, devices, computer program products and/or computer-implemented methods of use provided herein relate to neural network-based ultrasound image prediction and compounding. A system can comprise a memory that can store computer executable instructions. The system can further comprise a processor that can execute the computer executable instructions to facilitate performance of operations comprising generating one or more first ultrasound images by applying an image prediction function to respective second ultrasound images, wherein the image prediction function can leverage redundancies between the respective second ultrasound images to predict the one or more first ultrasound images. The operations can further comprise generating a set of ultrasound images comprising the one or more first ultrasound images and the respective second ultrasound images. The operations can further comprise generating a compounded image by computing a weighted average of respective ultrasound images comprised in the set of ultrasound images.

### CROSS-REFERENCE TO RELATED APPLICATIONS

This application claims priority to India Provisional Patent Application No. 20/244,1029030 filed on Apr. 10, 2024, entitled “TRAINED COMPOUNDING OPERATOR TO IMPROVE ULTRASOUND SYSTEM FRAME RATE.” The entireties of the aforementioned application are incorporated by reference herein.

### TECHNICAL FIELD

The subject disclosure relates to neural networks and, more specifically, to neural network-based ultrasound image prediction and compounding.

### BACKGROUND

Ultrasound imaging systems can generate ultrasound images at a limited rate. Reducing the number of transmits to increase the frame rate involves compromising on image quality metrics such as field of view, contrast, resolution and presence of artifacts. Compounding (averaging multiple acquired ultrasound images) coherently (with phase) or incoherently (without phase) to generate compounded images can trade temporal resolution for increased spatial resolution and contrast, thereby further limiting the frame rate. Additionally, conventional linear compounding techniques are limited to the use of fixed values that are not adaptive to underlying data.

### SUMMARY

The following presents a summary to provide a basic understanding of one or more embodiments described herein. This summary is not intended to identify key or critical elements, delineate scope of particular embodiments or scope of claims. Its sole purpose is to present concepts in a simplified form as a prelude to the more detailed description that is presented later. In one or more embodiments described herein, systems, computer-implemented methods, apparatus and/or computer program products that enable neural network-based ultrasound image prediction and compounding are discussed.

In an embodiment, a system is provided. The system can comprise a memory that can store computer executable instructions. The system can further comprise a processor that can execute the computer executable instructions that, when executed by the processor, facilitate performance of operations comprising generating one or more first ultrasound images by applying an image prediction function to respective second ultrasound images, where the image prediction function can leverage redundancies between the respective second ultrasound images to predict the one or more first ultrasound images. The operations can further comprise generating a set of ultrasound images comprising the one or more first ultrasound images and the respective second ultrasound images. The operations can further comprise generating a compounded image by computing a weighted average of respective ultrasound images comprised in the set of ultrasound images.

In another embodiment, a computer-implemented method is provided. The computer-implemented method can comprise predicting, by a system operatively coupled to a processor, respective weights for respective ultrasound images comprised in a set of ultrasound images by applying a weight prediction function to the respective ultrasound images. The computer-implemented method can further comprise computing, by the system, based on the respective weights, a weighted average of the respective ultrasound images in a convolutional manner. The computer-implemented method can further comprise generating, by the system, a compounded image based on the computing.

In yet another embodiment, a computer program product is provided. The computer program product can comprise a non-transitory computer readable memory having program instructions embodied therewith, the program instructions executable by a processor to cause the processor to generate one or more first ultrasound images by applying an image prediction function to respective second ultrasound images, where the image prediction function can leverage redundancies between the respective second ultrasound images to predict the one or more first ultrasound images. The program instructions can be further executable by the processor to cause the processor to generate a set of ultrasound images comprising the one or more first ultrasound images and the respective second ultrasound images. The program instructions can be further executable by the processor to cause the processor to predict respective weights for respective ultrasound images comprised in the set of ultrasound images by applying a weight prediction function to the respective ultrasound images. The program instructions can be further executable by the processor to cause the processor to generate a compounded image by computing, based on the respective weights, a weighted average of the respective ultrasound images in a convolutional manner.

### BRIEF DESCRIPTION OF THE DRAWINGS

The patent or application file contains at least one drawing executed in color. Copies of this patent or application publication with color drawing(s) will be provided by the Office upon request and payment of the necessary fee.

FIG. 1 illustrates a block diagram of an example, non-limiting system that can train a multi-stage machine learning model to generate new ultrasound images from existing ultrasound images in accordance with one or more embodiments described herein.

FIG. 2 illustrates another block diagram of an example, non-limiting system that can train a multi-stage machine learning model to generate new ultrasound images from existing ultrasound images in accordance with one or more embodiments described herein.

FIG. 3 illustrates a flow diagram of an example, non-limiting process to generate a compounded image from a set of ultrasound images.

FIG. 4 illustrates a flow diagram of an example, non-limiting method that can be employed to predict new ultrasound images by applying an image prediction function to a set of existing ultrasound images in accordance with one or more embodiments described herein.

FIG. 5 illustrates a flow diagram of an example, non-limiting method that can be employed to predict new ultrasound images by applying an image prediction function to a set of existing ultrasound images in accordance with one or more embodiments described herein.

FIG. 6 illustrates example, non-limiting image sets that show comparisons between ground truth ultrasound images versus ultrasound images predicted by employing an image prediction function in accordance with one or more embodiments described herein.

FIG. 7 illustrates example, non-limiting image sets that show comparisons between ground truth ultrasound images versus ultrasound images predicted by employing an image prediction function in accordance with one or more embodiments described herein.

FIG. 8 illustrates example, non-limiting image sets that show comparisons between compounded images based on conventional compounding versus compounded images based on ultrasound images predicted by employing an image prediction function in accordance with one or more embodiments described herein.

FIG. 9 illustrates example, non-limiting image sets that show comparisons between compounded images based on conventional compounding versus compounded images based on ultrasound images predicted by employing an image prediction function in accordance with one or more embodiments described herein.

FIG. 10 illustrates an example, non-limiting image showing a cyst phantom in accordance with one or more embodiments described herein.

FIG. 11 illustrates example, non-limiting graphs showing lateral contrast profiles based on a cyst phantom in accordance with one or more embodiments described herein.

FIG. 12 illustrates example, non-limiting graphs showing axial contrast profiles based on a cyst phantom in accordance with one or more embodiments described herein.

FIG. 13 illustrates example, non-limiting image sets that show comparisons between compounded images based on conventional compounding versus compounded images based on ultrasound images predicted by employing an image prediction function in accordance with one or more embodiments described herein.

FIG. 14 illustrates example, non-limiting images to show a conventional approach to linear compounding contrary to the embodiments of the present disclosure.

FIG. 15 illustrates a flow diagram of an example, non-limiting method that shows a reformulation of the conventional approach to linear compounding.

FIG. 16 illustrates flow diagrams of example, non-limiting methods that can employ a neural network model to compound ultrasound images in accordance with one or more embodiments described herein.

FIG. 17 illustrates example, non-limiting image sets that show comparisons between results generated by conventional compounding and results generated by a neural network model in accordance with one or more embodiments described herein.

FIG. 18 illustrates an example, non-limiting image showing a cyst phantom in accordance with one or more embodiments described herein.

FIG. 19 illustrates example, non-limiting graphs showing lateral contrast profiles based on a cyst phantom in accordance with one or more embodiments described herein.

FIG. 20 illustrates example, non-limiting graphs showing axial contrast profiles based on a cyst phantom in accordance with one or more embodiments described herein.

FIG. 21 illustrates a diagram of an example, non-limiting multi-stage model that can generate a compounded image from ultrasound images in accordance with one or more embodiments described herein.

FIG. 22 illustrates example, non-limiting image sets that show stagewise results based on conventional compounding.

FIG. 23 illustrates example, non-limiting image sets that show outputs generated by an intermediate stage of a multi-stage model in accordance with one or more embodiments described herein.

FIG. 24 illustrates example, non-limiting image sets that show outputs generated by a second stage of a multi-stage model in accordance with one or more embodiments described herein.

FIG. 25 illustrates an example, non-limiting image showing a cyst phantom in accordance with one or more embodiments described herein.

FIG. 26 illustrates example, non-limiting graphs showing lateral contrast profiles based on a cyst phantom in accordance with one or more embodiments described herein.

FIG. 27 illustrates example, non-limiting graphs showing axial contrast profiles based on a cyst phantom in accordance with one or more embodiments described herein.

FIG. 28 illustrates example, non-limiting image sets that show in vivo results based on test data in accordance with one or more embodiments described herein.

FIG. 29A illustrates a flow diagram of an example, non-limiting method that can be employed to generate a compounded image by applying a weight prediction function to ultrasound images in accordance with one or more embodiments described herein.

FIG. 29B illustrates a flow diagram of an example, non-limiting method that can be employed to generate a compounded image by applying an image prediction function to predict new ultrasound images and a weight prediction function to compound ultrasound images in accordance with one or more embodiments described herein.

FIG. 30 illustrates a block diagram of an example, non-limiting operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background section, Summary section or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

### Definitions

Transmits/frames/angles: Transmits refer to ultrasound images. Ultrasound images can be generated by ultrasound imaging systems comprising ultrasound devices such as ultrasound transducers. Ultrasound images can also be known as transmits, frames or angles.

Compounded image: An ultrasound image generated by an ultrasound imaging system by averaging multiple ultrasound images. Ultrasound imaging systems often employ image compounding to combine multiple ultrasound images acquired from different steering angles or at different times, via ultrasound devices such as ultrasound transducer, to produce a single clearer image.

Frame rate: The number of compounded images generated per second by an ultrasound imaging system.

Ultrasound imaging systems can generate ultrasound images (i.e., compounded images) at a rate limited by the number of transmits (i.e., the number of ultrasound images employed to generate the compounded image). For example, in ultrasound imaging, multiple ultrasound images are compounded to generate a compounded image (i.e., an ultrasound image). To generate a single compounded image, a snapshot of an ultrasound image is acquired, and multiple such snapshots are averaged. Each ultrasound image to be compounded can be acquired at a different transmit angle. That is, the beam (i.e., sound waves) is steered at different angles and added together with phase. However, increasing the number of ultrasound images employed to generate a compounded image can reduce the frame rate, that is, generate fewer compounded images per second because an ultrasound imaging system can only handle a certain number of ultrasound images at any given time and render fewer compounded images per second if the number of ultrasound images employed for compounding is increased. Reducing the number of transmits to increase the frame rate involves compromising on image quality metrics such as field of view, contrast, resolution, and presence of artifacts. Compounding (averaging multiple acquired ultrasound images) coherently (with phase) or incoherently (without phase) can trade temporal resolution for increased spatial resolution and contrast, thereby further limiting the frame rate. Additionally, conventional linear compounding techniques are limited to the use of fixed values that are not adaptive to underlying data. Thus, ultrasound imaging techniques that can generate high quality ultrasound images without reducing the frame rate can be desirable.

Various embodiments of the present disclosure can be implemented to produce a solution to the above problems. Embodiments described herein include systems, computer-implemented methods, and computer program products that can generate a compounded image from fewer ultrasound images than employed in conventional compounding. The compounded images thus generated can have increased image contrast than a compounded image generated via conventional compounding with a greater number of ultrasound images. Consequently, the benefits of both high frame rate, and increased contrast, can be achieved in compounded images generated by an ultrasound imaging system. Improved contrast in ultrasound images generated from fewer number of ultrasound images as compared to those employed in conventional compounding can achieve improved image quality and improved temporal resolution as compared to the image quality and temporal resolution in ultrasound images generated by conventional compounding techniques. The various embodiments herein can be applied across product lines based on or comprising ultrasound imaging systems, machines, devices and/or technologies. For example, different ultrasound imaging systems having respectively different amounts of trade-offs in image quality and frame rate can be developed for different entities or customers. For example, high frame rates are desirable when imaging moving structures such as the heart, but when imaging organs other than the heart, image quality can take precedence. Accordingly, different ultrasound imaging systems can be developed. Additionally, it should be appreciated that the various embodiments disclosed herein can be applicable to healthcare related fields as well as non-healthcare related fields.

In at least some embodiments, a neural network-based approach for predicting new ultrasound images based on a set of existing ultrasound images can be employed to improve the frame rate. For example, a neural network model (e.g., neural network model 202) can be employed to sequentially predict new ultrasound images, and the set of existing ultrasound images and the new ultrasound images can be compounded to generate a compounded image. The compounded image can have improved temporal resolution as compared to a compounded image generated by conventional techniques, wherein the ultrasound images that are compounded can be generated by an ultrasound device as opposed to being predicted by a neural network model. Such embodiments can enable ultrasound imaging systems with increased frame rates by offloading a portion of the ultrasound image generation to a neural network model. An increased frame rate can be generally desirable when generating medical images, and specifically to image moving structures such as cardiac anatomies, etc. Additionally, such embodiments can increase the ultrasound frame rate in existing ultrasound machines, and improve temporal resolution of compounded images as compared to the results produced by conventional compounding techniques and methods. The neural network model employed to predict the new ultrasound images can be a simpler and more explainable model than existing neural networks employed for predictive tasks.

In at least some embodiments, a trained compounding operator can be employed to generated compounded images from ultrasound images. The trained compounding operator can be a neural network model (e.g., neural network model 204) that can employ a non-linear compounding approach to generate a compounded image by predicting weights for respective ultrasound images followed by compounding the ultrasound images based on the predicted weights. The neural network model can overcome limitations imposed by conventional compounding techniques by employing fewer ultrasound images to generate a compounded image than employed by conventional compounding techniques. Such embodiments can generate compounded images with increased contrast as compared to compounded images generated by conventional techniques. Additionally, such embodiments can increase the ultrasound frame rate in existing ultrasound machines. In one or more embodiments, the neural network model employed to generate the compounded images can be incorporated in a multi-stage neural network model to generate compounded images with similar image quality, improved contrast, improved temporal resolution and increased frame rates as compared to those generated by conventional compounding techniques. As stated elsewhere herein, improved image quality (e.g., contrast, temporal resolution, etc.) and higher frame rates are desirable in medical images. Further, the neural network model employed to generate the compounded image can be directly employed as a trained operator to generate comparable results, and the neural network model can be a simpler and more explainable model than existing neural networks employed for predictive tasks.

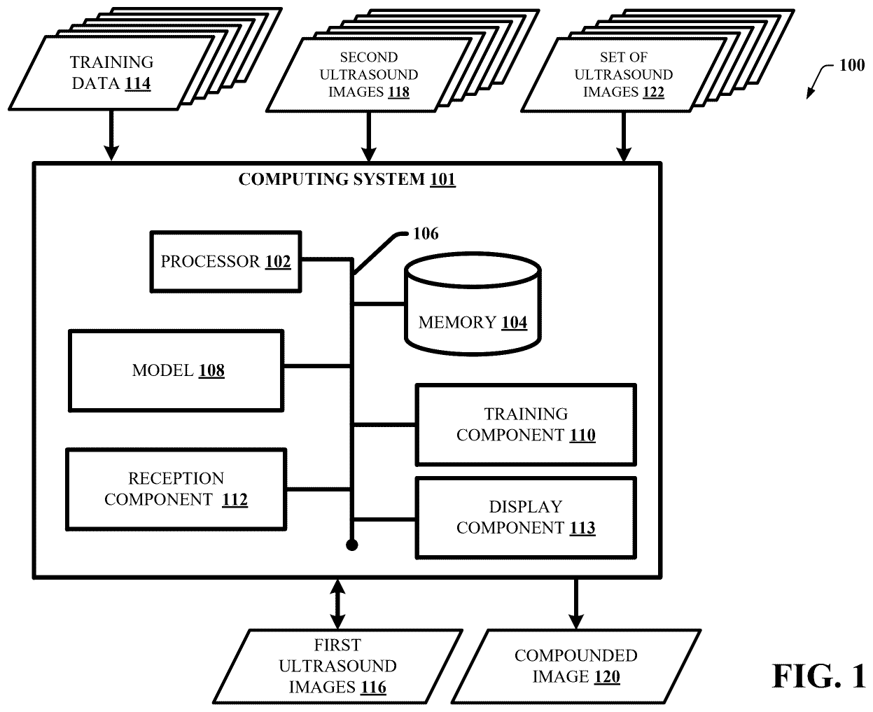

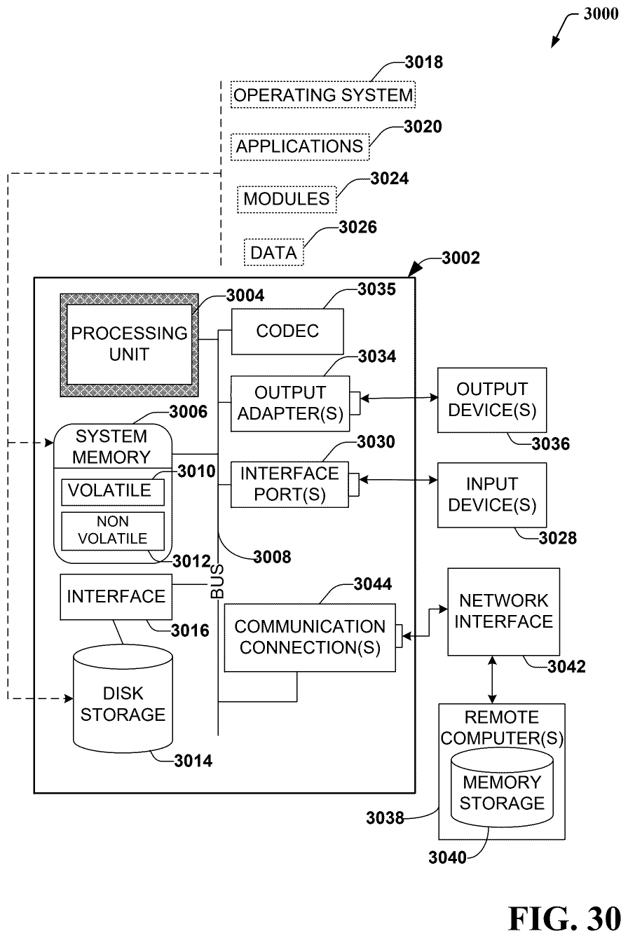

The embodiments depicted in one or more figures described herein are for illustration only, and as such, the architecture of embodiments is not limited to the systems, devices and/or components depicted therein, nor to any particular order, connection and/or coupling of systems, devices and/or components depicted therein. For example, in one or more embodiments, the non-limiting systems described herein, such as non-limiting system 100 as illustrated at FIG. 1, and/or systems thereof, can further comprise, be associated with and/or be coupled to one or more computer and/or computing-based elements described herein with reference to an operating environment, such as the operating environment 3000 illustrated at FIG. 30. For example, non-limiting system 100 can be associated with, such as accessible via, a computing environment 3000 described below with reference to FIG. 30, such that aspects of processing can be distributed between non-limiting system 100 and the computing environment 3000. In one or more described embodiments, computer and/or computing-based elements can be used in connection with implementing one or more of the systems, devices, components and/or computer-implemented operations shown and/or described in connection with FIG. 1 and/or with other figures described herein.

FIG. 1 illustrates a block diagram of an example, non-limiting system 100 that can train a multi-stage machine learning model to generate new ultrasound images from existing ultrasound images in accordance with one or more embodiments described herein.

Turning now to the drawings, FIG. 1 illustrates a block diagram of an example, non-limiting system 100 that facilitates enhancing the quality of 3D anatomy scan images by employing deep learning in accordance with one or more embodiments of the disclosed subject matter. Embodiments of systems described herein can include one or more machine-executable components embodied within one or more machines (e.g., embodied in one or more computer-readable storage media associated with one or more machines). Such components, when executed by the one or more machines (e.g., processors, computers, computing devices, virtual machines, etc.) can cause the one or more machines to perform the operations described.

Non-limiting system 100 and/or the components of non-limiting system 100 can be employed to use hardware and/or software to solve problems that are highly technical in nature (e.g., related to ultrasound imaging, machine learning, image prediction and compounding, etc.), that are not abstract and that cannot be performed as a set of mental acts by a human. Further, some of the processes performed may be performed by specialized computers for carrying out defined tasks related to predicting and compounding ultrasound images. Non-limiting system 100 and/or components of non-limiting system 100 can be employed to solve new problems that arise through advancements in technologies mentioned above and/or the like. Non-limiting system 100 can provide improvements to ultrasound imaging systems by improving contrast, temporal resolution, overall image quality of compounded images and by increasing frame rates associated with generation of the compounded images as compared to those generated by conventional compounding techniques.

In this regard, non-limiting system 100 can be and/or include various computer executable components. In the embodiment shown, these computer executable components can include model 108, training component 110, reception component 112 and display component 113. These computer/machine executable components (and others described herein) can be stored in memory associated with the one or more machines. The memory can further be operatively coupled to at least one processor, such that the components can be executed by the at least one processor to perform the operations described. For example, in some embodiments, these computer/machine executable components can be stored in memory 104 of computing system 101 which can be coupled to processor 102 for execution thereof. Examples of said memory and processor as well as other suitable computer or computing-based elements, can be found with reference to FIG. 30, and can be used in connection with implementing one or more of the systems or components shown and described in connection with FIG. 1 or other figures disclosed herein.

For example, in one or more embodiments, non-limiting system 100 can comprise computing system 101. Computing system 101 can further comprise processor 102 (e.g., computer processing unit, microprocessor, classical processor, and/or like processor). In one or more embodiments, a component associated with computing system 101, as described herein with or without reference to the one or more figures of the one or more embodiments, can comprise one or more computer and/or machine readable, writable and/or executable components and/or instructions that can be executed by processor 102 to enable performance of one or more processes defined by such component(s) and/or instruction(s).

In one or more embodiments, computing system 101 can comprise a computer-readable memory (e.g., memory 104) that can be operably connected to processor 102. Memory 104 can store computer executable instructions that, upon execution by processor 102, can cause processor 102 and/or one or more other components of computing system 101 (e.g., model 108, training component 110, reception component 112 and/or display component 113) to perform one or more actions. In one or more embodiments, memory 104 can store computer executable components (e.g., model 108, training component 110, reception component 112 and/or display component 113).

Computing system 101 and/or a component thereof as described herein, can be communicatively, electrically, operatively, optically and/or otherwise coupled to one another via bus 106. Bus 106 can comprise one or more of a memory bus, memory controller, peripheral bus, external bus, local bus, and/or another type of bus that can employ one or more bus architectures. One or more of these examples of bus 106 can be employed. In one or more embodiments, computing system 101 can be coupled (e.g., communicatively, electrically, operatively, optically and/or like function) to one or more external systems (e.g., a non-illustrated electrical output production system, one or more output targets, an output target controller and/or the like), sources and/or devices (e.g., classical computing devices, communication devices and/or like devices), such as via a network. In one or more embodiments, one or more of the components of computing system 101 can reside in the cloud, and/or can reside locally in a local computing environment (e.g., at a specified location(s)).

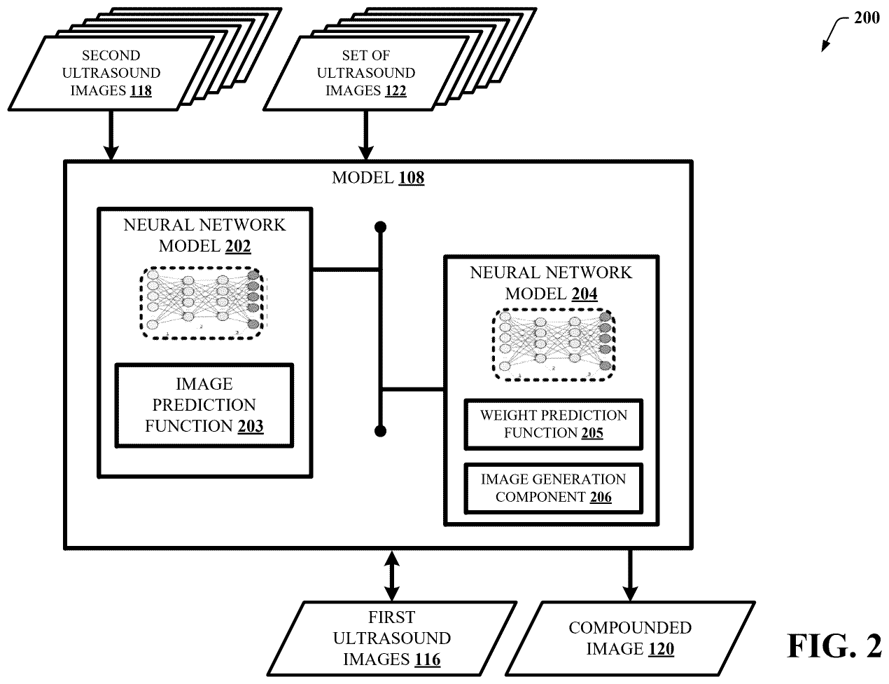

In addition to processor 102 and/or memory 104 described above, computing system 101 can comprise one or more computer and/or machine readable, writable and/or executable components and/or instructions that, when executed by processor 102, can enable performance of one or more operations defined by such component(s) and/or instruction(s). For example, as illustrated in FIGS. 1 and 2, model 108 can comprise neural network model 202 and/or neural network model 204, wherein model 108 can employ neural network model 202 to predict new ultrasound images by applying image prediction function 203 to existing ultrasound images, and model 108 can employ neural network model 204 to generate a compounded image by applying weight prediction function 205 to a set of ultrasound images, wherein the set of ultrasound images can comprise the existing ultrasound image and the new ultrasound images. In this regard, in one or more embodiments, model 108 can be a multi-stage model wherein neural network model 202 can generate outputs as a first stage of model 108 and neural network model 202 or a combination of models can generate outputs as a second stage of model 108 based on the outputs generated by neural network model 202. In some implementations, model 108 can be a machine learning model, an artificial intelligence (AI) model or another type of intelligent model. Similarly, in some implementations, model 108 can employ AI models in place of neural network model 202, neural network model 204 and/or another model comprised in model 108 to execute performance of one or more operations described in the various embodiments herein.

In one or more embodiments, reception component 112 can receive training data 114 that can be employed for model training and/or model application/inferencing. The type of scanned ultrasound images employed for training and inferencing should be the same modality but can vary with respect to numerous other factors (e.g., orientation, region of interest ROI, acquisition protocol, etc.). In the embodiment discussed, reception component 112 can access training data 114 for utilization by training component 110 to train and develop model 108. In one or more embodiments, training component 110 can train neural network model 202, neural network model 204, and/or another model by employing supervised machine learning to learn and perform one or more transformations. In this regard, the training process can involve training neural network model 202, neural network model 204, and/or another model to transform one or more low-resolution images into their corresponding high-resolution images while maintaining noise characteristics and tissue contrast characteristics of both types of images. For example, in some embodiments, reception component 112 can receive a set of scanned ultrasound images with respective fixed weights (w), and training component 110 can learn the respective fixed weights. Based on the learned fixed weights, training component 110 can generate a trained compounding model that can be employed in lieu of the respective fixed weights (w) to improve image contrast associated with a new scanned image. In one or more embodiments, display component 113 can display the ultrasound images generated by computing system 101 to a clinician, medical professional or another entity on a monitor via a user interface (UI).

More specifically, in an embodiment, model 108 can employ neural network model 202 to generate one or more first ultrasound images 116 by applying image prediction function 203 that can leverage redundancy between respective second ultrasound images 118 to predict the one or more first ultrasound images 116. In an embodiment, model 108 can employ neural network model 202 to further generate set of ultrasound images 122, wherein set of ultrasound images 122 can comprise the one or more first ultrasound images 116 and the respective second ultrasound images 118. In various embodiments, model 108 can generate compounded image 120 by computing a weighted average of respective ultrasound images comprised in set of ultrasound images 122. For example, model 108 can compute a weighted average of respective ultrasound images of the one or more first ultrasound images 116 and the respective second ultrasound images 118 to generate compounded image 120. In various embodiments, compounded image 120 can be an ultrasound image that is an enhanced scan image, and compounded image 120 can be a sum of delayed data comprised in set of ultrasound images 122.

In various embodiments, training component 110 can train neural network model 202, by employing training data 114, to generate the one or more first ultrasound images 116 from the respective second ultrasound images 118. For example, reception component 112 can receive training data 114 from an entity (e.g., hardware, software, neural network, AI, machine and/or human), and training component 110 can input a first set of training ultrasound images comprised in training data 114 to neural network model 202. Neural network model 202 can access the first set of training ultrasound images, and neural network model 202 can learn image prediction function 203 by predicting a sequence of training ultrasound images comprised in the first set of training ultrasound images based on a preceding sequence of training ultrasound images comprised in the first set of training ultrasound images. For example, training component 110 can divide the first set of training ultrasound images into a first sequence of training ultrasound images and a second sequence of training ultrasound images, wherein the first sequence of training ultrasound images can precede the second sequence of training ultrasound images. During training, neural network model 202 can learn to predict the second sequence of training ultrasound images (y-value) based on the first sequence of training ultrasound images (x-value) by adjusting the weights and parameters of neural network model 202 to reduce the training loss.

Upon learning image prediction function 203, neural network model 202 can apply image prediction function 203 to new data, such as second ultrasound images 118 to predict the one or more first ultrasound images 116. For example, neural network model 202 can predict m transmits, given (N-m) transmits. In various embodiments, neural network model 202 can apply image prediction function 203 after applying beamforming delays to the respective second ultrasound images 118. Beamforming delays refer to the time adjustments applied to ultrasound signals received or transmitted by an array of transducers to improve the quality of ultrasound images. Thus, image prediction function 203 can be applied to the respective second ultrasound images 118 after applying such beamforming delays. Each ultrasound image of the one or more first ultrasound images 116 generated by neural network model 202 can be a function of several ultrasound images comprising the respective second ultrasound images 118. The respective second ultrasound images 118 can be generated by an ultrasound sensor or transducer, and each ultrasound image of second ultrasound images 118 can be a transmit that can be a function of the acquired radio frequency (RF) data (i.e., the sampling frequency at which the data associated with the respective second ultrasound images 118 can be acquired via an ultrasound sensor or transducer) and the corresponding transmit and receive delays. Neural network model 202 can leverage the redundancy in the time delays between, and the data associated with, the respective second ultrasound images 118, in addition to any overlap of ultrasound images comprised in the respective second ultrasound images 118.

As stated elsewhere herein, model 108 can generate compounded image 120 by computing a weighted average of respective ultrasound images comprised in set of ultrasound images 122. In various embodiments, data from the respective ultrasound images comprised in set of ultrasound images 122 can be a function of the respective second ultrasound images 118 and a time delay corresponding to the respective second ultrasound images 118.

In an embodiment, model 108 can access a set of fixed weights associated with set of ultrasound images 122 and generate compounded image 120 by averaging the set of fixed weights. The set of fixed weights can be stored in memory 104 or another system memory.

In another embodiment, model 108 can employ neural network model 204 to predict respective weights for the respective ultrasound images by applying weight prediction function 205 to generate compounded image 120, wherein neural network model 204 can further employ image generation component 206 to generate compounded image 120. Image generation component 206 can generate compounded image 120 by computing, based on the respective weights, the weighted average of the respective ultrasound images in a convolutional manner. In various embodiments, neural network model 204 can be trained by training component 110 to predict the respective weights for the respective ultrasound images. For example, reception component 112 can receive training data 114 from an entity (e.g., hardware, software, neural network, AI, machine and/or human), and training component 110 can input a second set of training ultrasound images comprised in training data 114 to train neural network model 204. Neural network model 204 can access the second set of training ultrasound images and learn weight prediction function 205 by learning respective fixed weights associated with respective training ultrasound images comprised in the second set of training ultrasound images. Neural network model 204 can learn the respective fixed weights by analyzing contrast present in a training compounded image generated from the second set of training ultrasound images.

For example, the second set of training ultrasound images can represent a corpus of images comprising raw transmits that do not have any weight assigned to/associated with them. Training component 110 can train neural network model 204 to learn and reformulate respective weights for respective ultrasound images comprised in the corpus of images, based on the contrast present in a training ultrasound image associated with the corpus of images, and the reformulated respective weights can be stored in system memory (e.g., memory 104). In one or more embodiments, neural network model 204 can learn by attempting to generate the contrast of a higher number of transmits from a fewer number of transmits.

More specifically, the second set of training ultrasound images can be associated with a training compounded image having a certain amount of contrast, wherein the second set of training ultrasound images and the training compounded image can be comprised in training data 114. During training, neural network model 204 can learn by attempting to match the contrast of the training compounded image to the respective weights associated with the respective ultrasound images comprised in the second set of training ultrasound images. For example, the input (x-value) to neural network model 204 can be raw ultrasound images and a training compounded image (y-value) corresponding to the raw ultrasound images, and neural network model 204 can learn the weights applicable to each raw ultrasound image based on the contrast present in the training compounded image, such that the contrast present in the training compounded image can be generated by averaging the raw ultrasound images. As a result of the training, neural network model 204 can learn weight prediction function 205 that can be applied to new ultrasound images such as, for example, set of ultrasound images 122 comprising the one or more first ultrasound images 116 and the respective second ultrasound images 118, to generate compounded image 120. That is, compounded image 120 generated by neural network model 204 can be a function of the one or more first ultrasound images 116. In this regard, the weights learned by neural network model 204 are the compounding weights for the respective ultrasound images, wherein the compounding weights are dependent on neural network parameters associated with neural network model 204. In conventional compounding, the compounded image is a function that is a set of fixed weights, which makes the function a linear combination. On the contrary, the various embodiments herein can employ a non-linear function (e.g., weight prediction function 205) that can be learned by neural network model 204 by employing a neural network architecture of neural network model 204.

Thus, neural network model 204 can be trained to employ non-linearities present in the neural network architecture of neural network model 204 in a convolutional manner, across set of ultrasound images 122 having lower contrasts, to generate compounded image 120 with higher contrast.

In one or more embodiments, neural network model 204 can apply weight prediction function 205 in lieu of a set of fixed weights associated with the respective ultrasound images comprised in set of ultrasound images 122, wherein a weight vector associated with the set of fixed weights can be parametrized as a composition of layers of neural network model 204.

In one or more embodiments, compounded image 120 can be generated by a multi-stage model comprising neural network model 204 in a cascading approach. For example, an overlapping sliding queue of data corresponding to the respective ultrasound images comprised in set of ultrasound images 122 can be input into/accessed by a plurality of models to generate an output. Thereafter, the output can be input into/accessed by neural network model 204 to generate compounded image 120. In an embodiment, the plurality of models can be identical to neural network model 204. In another embodiment, the plurality of models can be different from neural network model 204. In one or more embodiments, the cascading approach can increase contrast in compounded image 120. Additionally, in one or more embodiments, employing the overlapping sliding queue of data can increase a frame rate associated with an ultrasound imaging system. That is, compounded image 120 can have higher contrast and be associated with a higher frame rate when generated via the cascading approach, as opposed to being generated without employing the cascading approach.

FIG. 2 illustrates another block diagram of an example, non-limiting system 200 that can train a multi-stage machine learning model to generate new ultrasound images from existing ultrasound images in accordance with one or more embodiments described herein. Repetitive description of like elements and/or processes employed in respective embodiments is omitted for sake of brevity.

Non-limiting system 200 illustrates the system of model 108 described with reference to FIG. 1. In one or more embodiments, model 108 can comprise neural network model 202, neural network model 204, and/or one or more additional neural network models. As stated elsewhere herein, model 108 can employ neural network model 202 to predict first ultrasound images 116, wherein neural network model 202 can predict the first ultrasound images by applying an image prediction function to second ultrasound images 118. Model 108 can generate set of ultrasound images 122 by combining first ultrasound images 116 and second ultrasound images 118. In some embodiments, model 108 can additionally employ neural network model 204 to generate compounded image 120. Neural network model 204 can predict respective weights for the respective ultrasound images comprised in set of ultrasound images 122 by applying a weight prediction function followed by computing, based on the respective weights, a weighted average of the respective ultrasound images in a convolutional manner to generate compounded image 120.

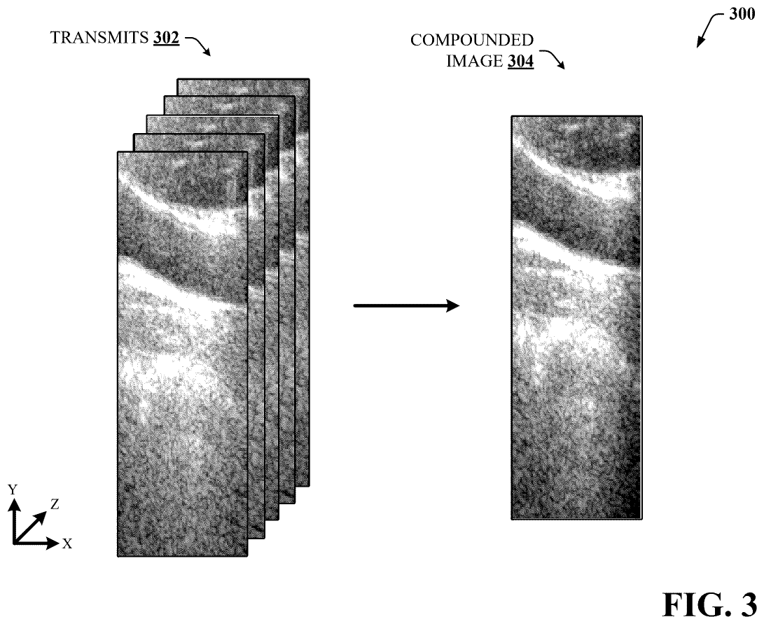

FIG. 3 illustrates a flow diagram of an example, non-limiting process 300 to generate a compounded image from a set of ultrasound images. Non-limiting process 300 illustrates a conventional process of generating a compounded image from a set of ultrasound images. In this regard, FIG. 3 is intended to highlight the problems associated with conventional compounding techniques in contrast to the embodiments of the present disclosure.

In the realm of ultrasound imaging, various existing techniques can be employed to generate ultrasound images by compounding. For example, one or more existing techniques can be employed to generate compounded image 304 from transmits 302, wherein transmits 302 can comprise a plurality of raw ultrasound images. In FIG. 3 and one or more other figures, a three dimensional (3D) Cartesian coordinate system is illustrated for reference, wherein the X-axis corresponds to the direction of the width of each ultrasound image in a set of ultrasound images (e.g., transmits 302), the Y-axis corresponds to the direction of the depth of each ultrasound image in the set of ultrasound images, and the Z-axis corresponds to the number of transmits (N) in the set of ultrasound images.

Existing ultrasound systems can compound multiple ultrasound images to improve the image quality of the compounded images. Such existing ultrasound systems can perform compounding coherently (with phase information) to improve resolution and signal-to-noise ratio (SNR) in a compounded image, or incoherently (without phase) to reduce speckle in the compounded image. However, compounding a large number of frames (N) limits achievable temporal resolution with a desired image quality to specific applications. On the contrary, the various embodiments herein can leverage redundancy between respective ultrasound images comprised in a set of transmits to predict (e.g., via neural network model 202) new ultrasound images. Such embodiments of the present disclosure can be applied on a deeper level in the signal chain, because the new ultrasound images can be predicted prior to generating the compounded image.

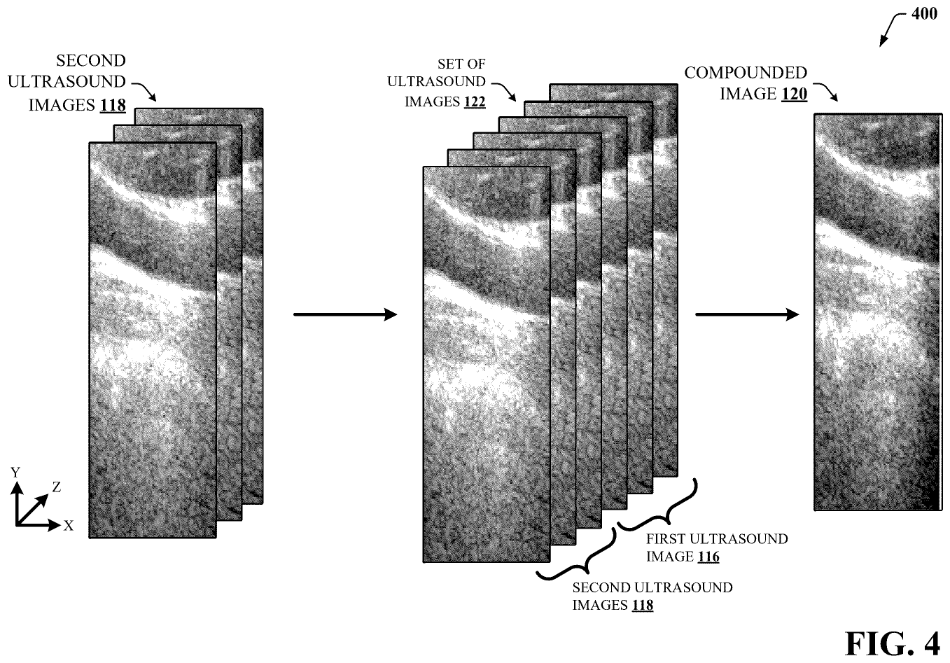

FIG. 4 illustrates a flow diagram of an example, non-limiting method 400 that can be employed to predict new ultrasound images by applying an image prediction function to a set of existing ultrasound images in accordance with one or more embodiments described herein. Repetitive description of like elements and/or processes employed in respective embodiments is omitted for sake of brevity.

In FIG. 4, second ultrasound images 118 represent acquired transmits, (N-m), first ultrasound images 116 represent predicted transmits, m, and set of ultrasound images 122 represent the total number of transmits, N, that can be generated by combining first ultrasound images 116 and second ultrasound images 118 and that can be employed to generate compounded image 120. Additionally, in FIG. 4, the data is illustrated as a volume of dimension depth×width×transmits, wherein the depth of each ultrasound image is illustrated along the Y-axis, the width of each ultrasound image is illustrated along the X-axis, and the number of transmits is illustrated along the Z-axis. The X-axis also illustrates the direction of channels corresponding to second ultrasound images 118 and set of ultrasound images 122.

As discussed with reference to FIGS. 1 and 2, in one or more embodiments, neural network model 202 can be trained by training component 110 to generate one or more first ultrasound images 116 by applying an image prediction function to respective second ultrasound images 118, wherein image prediction function 203 can leverage redundancy between the respective second ultrasound images 118 to predict the one or more first ultrasound images 116. Doing so can ameliorate the reduction in frame rate that can otherwise result due to a higher number of transmits, because an ultrasound system can render fewer frames per second if the number of transmits are increased. Additionally, neural network model 202 can generate set of ultrasound images 122 comprising the one or more first ultrasound images 116 and second ultrasound images 118. The set of ultrasound images 122 can be employed to generate compounded image 120 by computing a weighted average of respective ultrasound images comprised in set of ultrasound images 122.

Mathematically, considering several transmits, neural network model 202 can leverage redundancy in the data received from preceding k transmits to predict the data of subsequent transmits, as given by Equation 1.

$${T}_{m} = {f}_{N} ( {T}_{m - 1} , {T}_{m - 2} ... . {T}_{m - K} ) \qquad Equation 1$$

For example, neural network model 202 can apply an image prediction function (e.g., image prediction function 203) to an initial set of transmits (i.e., second ultrasound images 118), Fᵢ, wherein Fᵢ={F₁ F₂ . . . . Fᵢ Fᵢ₊₁ F_{N-m}}, to predict a subsequent set of frames (i.e., one or more first ultrasound images 116), Pⱼ, wherein Pⱼ={P₁ P₂ . . . Pⱼ Pⱼ₊₁ Pₘ}. Image prediction function 203 can be mathematically represented as f_{N}(θ) having parameters θ, and image prediction function 203 can be learnt by neural network model 202 via non-linearities present in neural network model 202. The predicted frame, Pⱼ, can be obtained as f_{N}({Fᵢ}; θ), where i<j and {Fᵢ} denotes a set of transmits preceding j.

The compounded image, I, (e.g., compounded image 120) based on a combination of Fᵢ and Pⱼ is the sum of N appropriately delayed data from transmits Tᵢ, as given by Equation 2.

$$I = {\sum }_{i = 1}^{N} {T}_{i} , \qquad Equation 2$$

wherein the set of transmits Tᵢ is comprised of the initial transmits Fᵢ and predicted frames Pⱼ.

The data from each transmit, Tᵢ, is a function of the received data, R_{d}, and the corresponding time delay d_{T}, as given by Equation 3.

$${T}_{i} = f ( {R}_{d} , {d}_{T} ) , wherein {R}_{d} = \{ \begin{matrix}{F}_{1} & {F}_{2} & ... & {F}_{i} & {F}_{i + 1} & {F}_{N - m}\end{matrix} \} . \qquad Equation 3$$

The time delay d_{T} is in turn a function of the transmit aperture, T_{A}, the receive aperture, R_{A}, and the steering angle, α, associated with an ultrasound imaging device employed to generate the transmits, as given by Equation 4. Ultrasound images are reconstructed by employing beamforming. To reconstruct ultrasound images on the receive side of an ultrasound transducer (as opposed to the transmit side), a time delay is typically be applied in the reverse direction. The time delay is applied to signals received by an array of transducer elements comprised in the ultrasound transducer, and the time delay calculation is based on the geometry of the transducer elements. Additionally, the time delay applied to reconstruct the ultrasound images is a combination of the transmit and receive delays, wherein the transmit and receive delays can be different from/unequal to one another.

$${d}_{T} = g ( {T}_{A} , {R}_{A} , α ) \qquad Equation 4$$

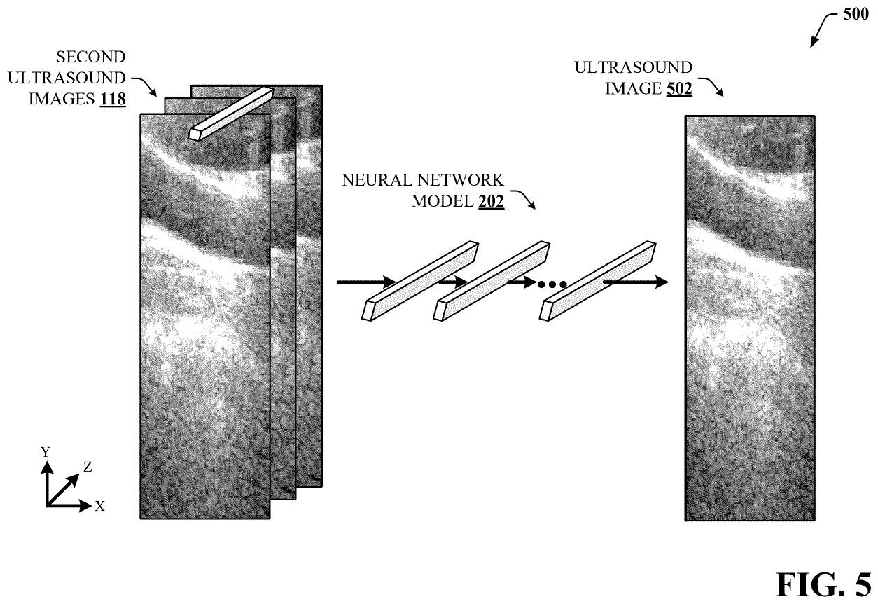

Some additional aspects related to predicting ultrasound images via neural network model 202 are illustrated in FIG. 5.

FIG. 5 illustrates a flow diagram of an example, non-limiting method 500 that can be employed to predict new ultrasound images by applying an image prediction function to a set of existing ultrasound images in accordance with one or more embodiments described herein. Repetitive description of like elements and/or processes employed in respective embodiments is omitted for sake of brevity.

With continued reference to FIG. 4, non-limiting method 500 illustrates the method of applying the image prediction function, f_{N}(θ), of neural network model 202 to second ultrasound images 118 to generate ultrasound image 502. Ultrasound image 502 can be one of the ultrasound images comprised in first ultrasound images 116. In FIG. 5, neural network model 202 is illustrated as different layers of neural networks. In one or more embodiments, the prediction mechanism of neural network model 202 can be applied on the transmit dimension (i.e., along the Z-axis) of second ultrasound images via the image prediction function, f_{N}(θ), learned by neural network model 202. Further, in one or more embodiments, the prediction mechanism of neural network model 202 can be applied to data comprised in second ultrasound images 118 after applying corresponding beamforming delays to second ultrasound images 118.

With continued reference to FIGS. 1-5, FIGS. 6-13 illustrate different results generated by employing neural network model 202 to predict new ultrasound images from existing ultrasound images in accordance with the various embodiments herein.

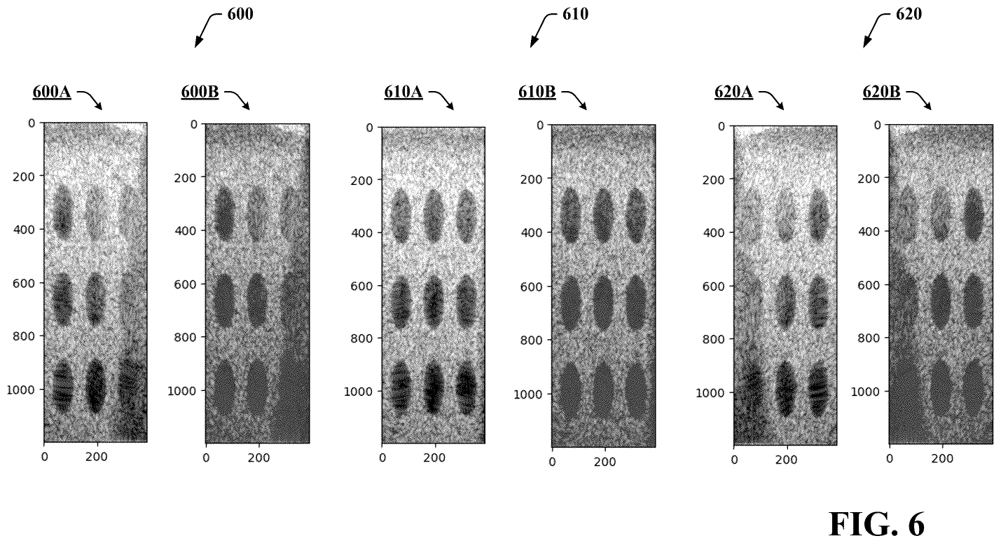

Specifically, FIG. 6 illustrates example, non-limiting image sets 600, 610 and 620 that show comparisons between ground truth ultrasound images versus ultrasound images predicted by employing an image prediction function in accordance with one or more embodiments described herein. Repetitive description of like elements and/or processes employed in respective embodiments is omitted for sake of brevity.

In non-limiting image set 600, non-limiting image set 610 and non-limiting image set 620, images 600A, 610A and 620A illustrate actual ground truth ultrasound images and images 600B, 610B and 620B illustrate ultrasound images generated by neural network model 202. In the experiments conducted to generate the images in FIG. 6, the input to neural network model 202 comprised multiple images and the resultant output was an individual image (e.g., images 600B, 610B or 620B).

In this regard, images 600B, 610B and 620B illustrate in silico ultrasound images that were predicted by neural network model 202 by employing simulated data from Field II from the Plane-wave Imaging Challenge in Medical UltraSound (PICMUS) dataset. The simulated data consisted of seventy-five ultrasound images (i.e., transmits/frames/angles) linearly spaced from steering angles negative (−) 16° to positive (+) 16°. The steering angle is the angle of the ultrasound source in an ultrasound transducer.

In each case, three preceding transmits were employed to predict the fourth transmit (i.e., 600B, 610B or 620B). Further, images 600B and 620B were obtained by employing transmits steered to the left and the right of a perpendicularly incident ultrasound beam.

For image 600B, transmit data at angles (−16°, −15.58°, −15.14°) was employed to predict transmit data at −14.7°. For image 610B, transmit data at angles (−3.03°, −2.59°, −2.16°) was employed to predict transmit data at −1.72°. For image 620B, transmit data at angles (+14.7°, +15.58°, 15.14°) was employed to predict transmit data at 16°. All angles were measured with respect to the normal, and all images in FIG. 5 are displayed on a 50 decibel (dB) dynamic range. Images 600B, 610B and 620B demonstrate that irrespective of steering angle, neural network model 202 can reliably/faithfully predict new ultrasound images.

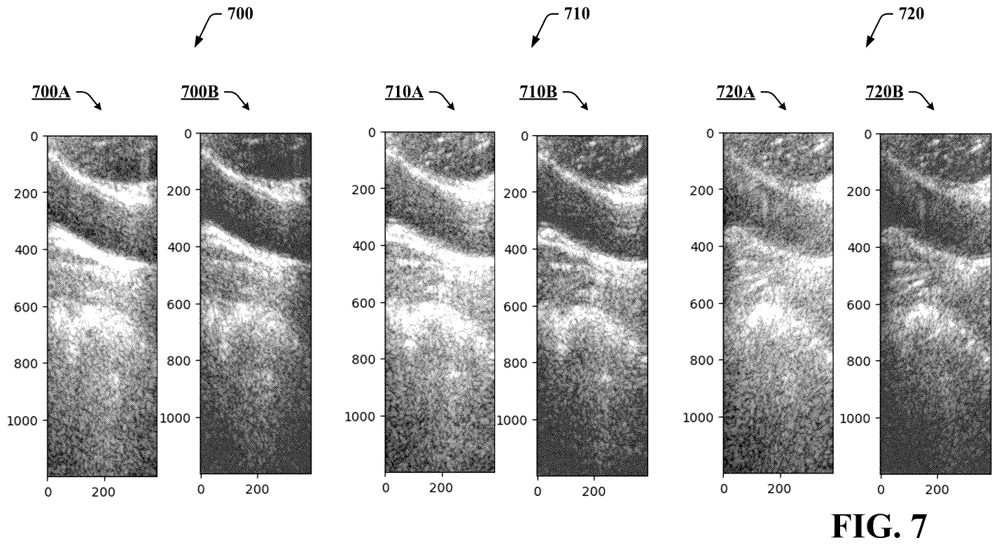

FIG. 7 illustrates example, non-limiting image sets 700, 710 and 720 that show comparisons between ground truth ultrasound images versus ultrasound images predicted by employing an image prediction function in accordance with one or more embodiments described herein. Repetitive description of like elements and/or processes employed in respective embodiments is omitted for sake of brevity.

In non-limiting image set 700, non-limiting image set 710 and non-limiting image set 720, images 700A, 710A and 720A illustrate actual ground truth ultrasound images and images 700B, 710B and 720B illustrate ultrasound images generated by neural network model 202. Images 700A, 710A and 720A represent known outputs for compounding the corresponding number of angles employed to generate images 700B, 710B or 720B.

Images 700B, 710B and 720B were generated based on a publicly available dataset comprising ultrasound images related to real persons. In each case, four preceding transmits were employed to predict the fifth transmit (i.e., 700B, 710B or 720B). It can be observed that neural network model 202 can reliably predict subsequent transmits based on initial transmits, irrespective of the initial transmit angle.

The publicly available dataset employed to generate images 700B, 710B and 720B represents an in vivo dataset. To generate images 700B, 710B and 720B, neural network model 202 was trained on simulated data from the PICMUS dataset described with reference to FIG. 6. However, during the training, neural network model 202 was not exposed to the dataset employed to generate images 700B, 710B and 720B. In other words, the trained network (i.e., neural network model 202) was trained on in silico data and validated on in vivo data, wherein images 700B, 710B and 720B illustrate results of the validation.

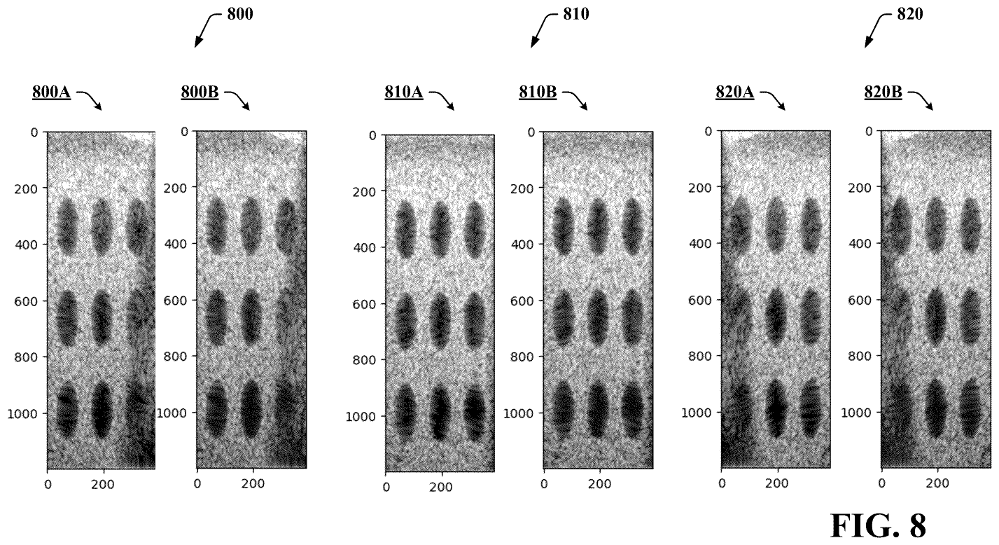

FIG. 8 illustrates example, non-limiting image sets 800, 810 and 820 that show comparisons between compounded images based on conventional compounding versus compounded images based on ultrasound images predicted by employing an image prediction function in accordance with one or more embodiments described herein. Repetitive description of like elements and/or processes employed in respective embodiments is omitted for sake of brevity.

In non-limiting image set 800, non-limiting image set 810 and non-limiting image set 820, images 800A, 810A and 820A illustrate ultrasound images generated by conventional compounding techniques, and images 800B, 810B and 820B illustrate ultrasound images generated by compounding ultrasound images predicted by neural network model 202 from existing ultrasound images.

In each of non-limiting image sets 800, 810 and 820, a coherently compounded image (e.g., image 800A, 810A or 820A) was constructed by employing ultrasound images acquired from an ultrasound device, and the compounded image was compared to another compounded image (e.g., image 800B, 810B or 820B) generated by employing ultrasound images predicted by neural network model 202. Images 800B, 810B and 820B demonstrate that the ultrasound images predicted by neural network model 202 (i.e., predicted transmits) can be adequate substitutions for in silico ultrasound images acquired from an ultrasound device (i.e., acquired transmits), without diminishing the image quality of a resultant compounded image, thereby increasing the corresponding frame rate. In other words, employing ultrasound images predicted by neural network model 202 instead of ultrasound images acquired directly from an ultrasound device does not diminish the image quality of the compounded image, regardless of the steering angle. Images 800B, 810B and 820B serve as a secondary validation for neural network model 202.

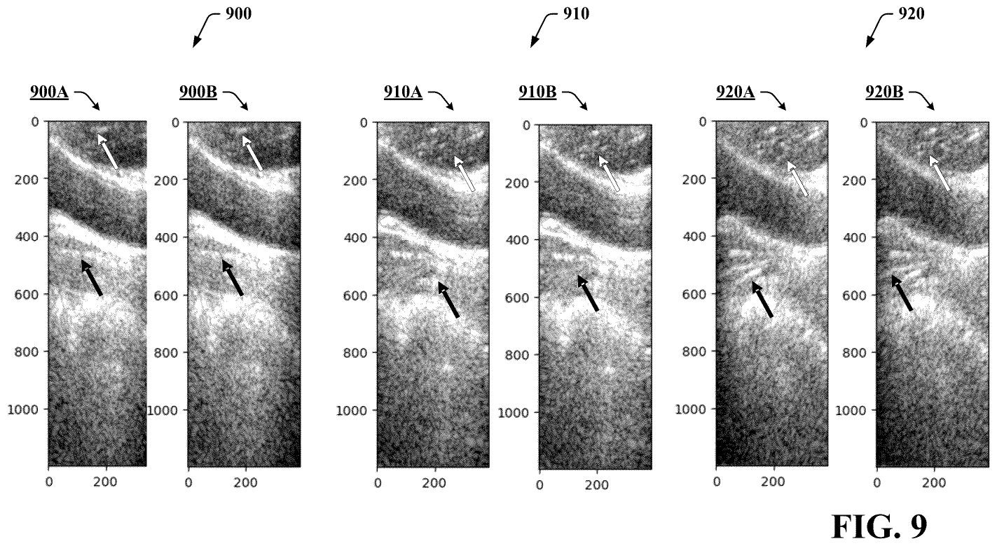

FIG. 9 illustrates example, non-limiting image sets 900, 910 and 920 that show comparisons between compounded images based on conventional compounding versus compounded images based on ultrasound images predicted by employing an image prediction function in accordance with one or more embodiments described herein. Repetitive description of like elements and/or processes employed in respective embodiments is omitted for sake of brevity.

While non-limiting images sets 800, 810 and 820 illustrated in silico results for neural network model 202, non-limiting images sets 900, 910 and 920 illustrate in vivo results for neural network model 202. In non-limiting image set 900, non-limiting image set 810 and non-limiting image set 920, images 900A, 910A and 920A illustrate ultrasound images generated by conventional compounding techniques, and images 900B, 910B and 920B illustrate ultrasound images generated by compounding ultrasound images predicted by neural network model 202 from existing ultrasound images.

Like FIG. 8, images 900B, 910B and 920B were generated by compounding ultrasound images predicted by neural network model 202, as opposed to compounding ultrasound images acquired from an ultrasound device. Images 900B, 910B and 920B demonstrate that employing ultrasound images predicted by neural network model 202 can generate a compounded image with increased temporal resolution and comparable image quality to that of a compounded image generated from ultrasound images acquired from an ultrasound device, without diminishing the image quality of the compounded image.

In each of images 900A, 900B, 910A, 910B, 920A and 920B, the arrows point to contrast. The white arrows point to near-field data, whereas the black arrows point to far-field data. Additionally, in images 900B, 910B and 920B, the arrows show that the anatomical details in the compounded images based on the ultrasound images predicted by neural network model 202 are preserved.

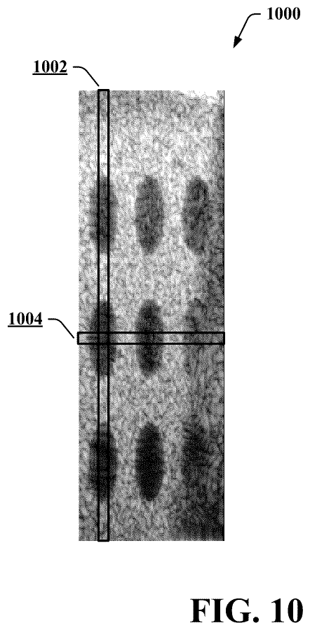

FIG. 10 illustrates an example, non-limiting image 1000 showing a cyst phantom in accordance with one or more embodiments described herein. Repetitive description of like elements and/or processes employed in respective embodiments is omitted for sake of brevity.

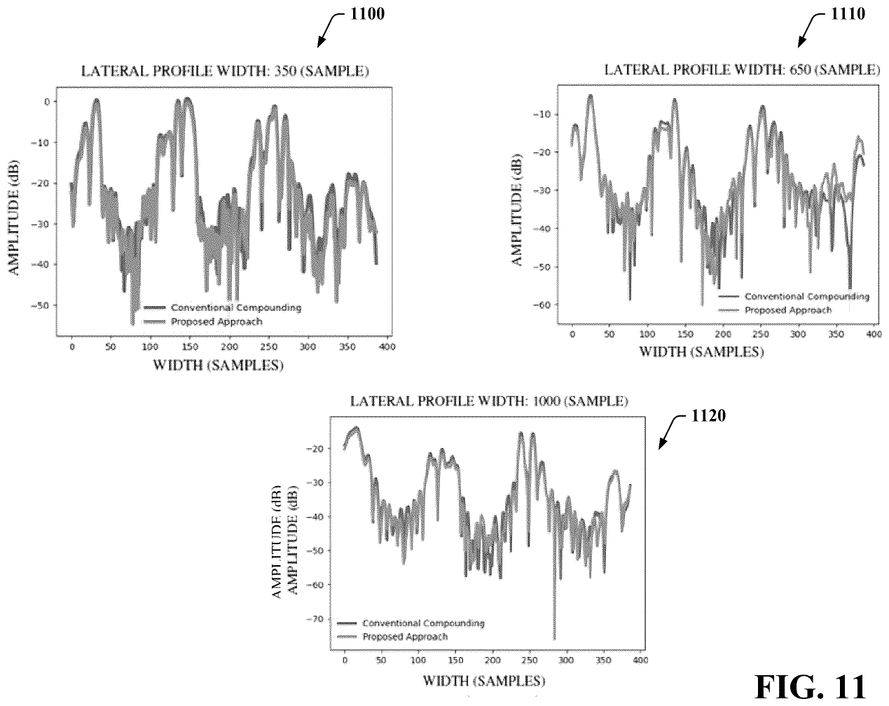

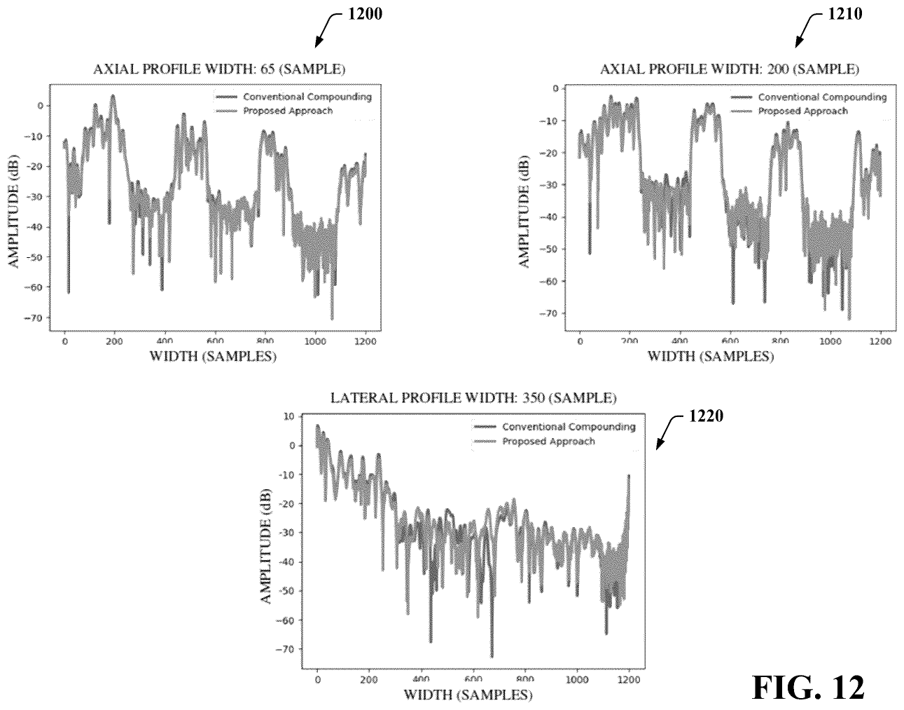

The cyst phantom illustrated by non-limiting image 1000 was employed to generate the lateral contrast profiles illustrated in FIG. 11 and the axial contrast profiles in FIG. 12. The dark spots in non-limiting image 1000 represent individual cysts in the cyst phantom. Each horizontal row of cysts in the cyst phantom corresponds to a graph in FIG. 11, whereas each vertical row of cysts in the cyst phantom corresponds to a graph in FIG. 12. For example, non-limiting graph 1110 was generated at the lateral location illustrated by strip 1004 in the cyst phantom and corresponds to a horizontal cross section across the middle row of cysts in non-limiting image 1000. Similarly, non-limiting graph 1200 was generated at the axial location illustrated by strip 1002 in the cyst phantom and corresponds to a vertical cross section across the leftmost column of cysts in non-limiting image 1000.

With continued reference to FIG. 10, FIG. 11 illustrates example, non-limiting graphs 1100, 1110 and 1120 showing lateral contrast profiles based on a cyst phantom in accordance with one or more embodiments described herein, and FIG. 12 illustrates example, non-limiting graphs 1200, 1210 and 1220 showing axial contrast profiles based on a cyst phantom in accordance with one or more embodiments described herein. Repetitive description of like elements and/or processes employed in respective embodiments is omitted for sake of brevity.

Non-limiting graphs 1100, 1110 and 1120 depict the contrast in the lateral direction across the cysts illustrated in the cyst phantom of FIG. 10 and non-limiting graphs 1200, 1210 and 1220 depict the contrast in the axial direction across the cysts illustrated in the cyst phantom of FIG. 10.

The respective lateral contrast profiles illustrated by non-limiting graphs 1100, 1110 and 1120 were obtained for the cyst phantom at three lateral locations (65, 200 and 350 sample(s) (laterally), respectively). For example, beginning at the top of the cyst phantom illustrated in FIG. 10, non-limiting graph 1100 corresponds to the topmost row of cysts, non-limiting graph 1110 corresponds to the middle row of cysts, and non-limiting graph 1120 corresponds to the bottommost row of cysts. Similarly, the respective axial contrast profiles illustrated by non-limiting graphs 1200, 1210 and 1220 were obtained for the cyst phantom at three axial locations (350, 650 and 1000 sample(s) (axially), respectively). For example, beginning at the left-hand side of the cyst phantom illustrated in FIG. 10, non-limiting graph 1200 corresponds to the leftmost column of cysts, non-limiting graph 1210 corresponds to the middle column of cysts, and non-limiting graph 1220 corresponds to the rightmost column of cysts.

In each of non-limiting graphs 1100, 1110, 1120, 1200, 1210 and 1220, the darker plot lines represent results based on conventional compounding techniques, whereas the lighter plot lines represent results based on the various embodiments presented herein. For example, the lighter plot lines represent the results based on generating compounded images from ultrasound images predicted by neural network model 202, as described with reference to at least FIG. 1. Evidently, the contrast profiles based on the embodiments disclosed herein do not show an appreciable change as compared to those based on conventional compounding.

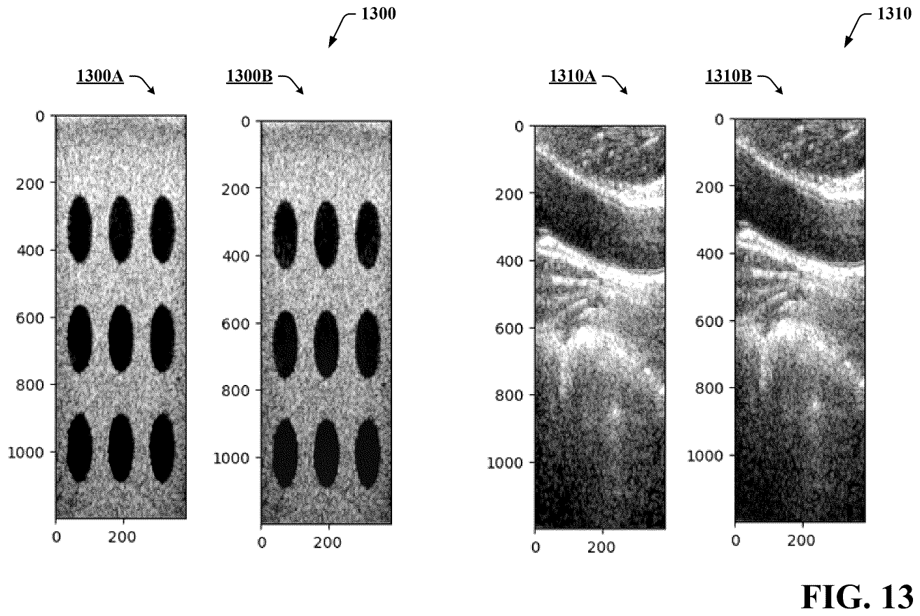

FIG. 13 illustrates example, non-limiting image sets 1300 and 1310 that show comparisons between compounded images based on conventional compounding versus compounded images based on ultrasound images predicted by employing an image prediction function in accordance with one or more embodiments described herein. Repetitive description of like elements and/or processes employed in respective embodiments is omitted for sake of brevity.

Non-limiting image set 1300 and non-limiting image set 1310 illustrate comparisons of compounded images generated via conventional compounding (i.e., images 1300A and 1310A) with compounded images generated from ultrasound images predicted by neural network model 202 (i.e., images 1300B and 1310B) for seventy-five ultrasound images (transmits/frames/angles). That is, each one of images 1300A, 1300B, 1310A and 1310B represent a compounded image generated by compounding seventy-five ultrasound images.

In the experiments conducted to generate the images of FIG. 13, images 1300A and 1310A were generated by compounding seventy-five ultrasound images directly acquired from an ultrasound device. Images 1300B and 1310B were also generated by compounding seventy-five ultrasound images; however, of the seventy-five ultrasound images, every fourth ultrasound image was predicted by neural network model 202 based on three preceding ultrasound images. For example, neural network model 202 was employed to generate the fourth image, eighth image, twelfth image, and so on, and 17 or 18 ultrasound images of the seventy-five ultrasound images employed to generate image 1300B or image 1310B were predicted by neural network model 202. On the contrary, none of the seventy-five ultrasound images employed to generate image 1300A or image 1310A via conventional compounding were predicted. Evidently, images 1300B and 1310B do not demonstrate an appreciable change in the image quality as compared to corresponding images 1300A and 1310A, despite 25% of the ultrasound images employed to generate each of image 1300B and image 1310B being predicted by neural network model 202.

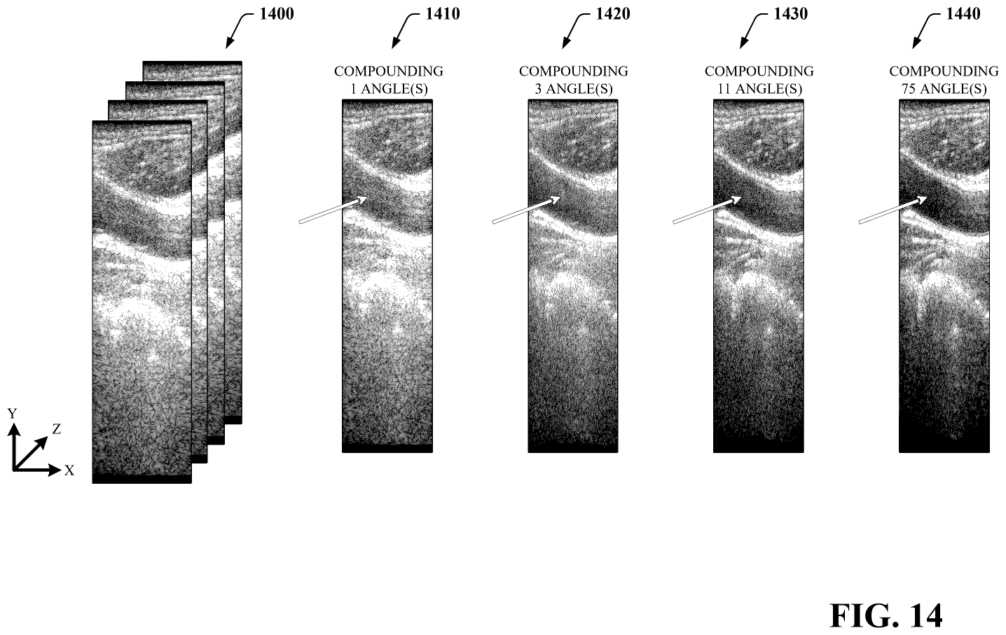

FIG. 14 illustrates example, non-limiting image 1400 and example, non-limiting images 1410, 1420, 1430 and 1440 to show a conventional approach to linear compounding contrary to the embodiments of the present disclosure. In FIG. 14, the depth of each ultrasound image is illustrated along the Y-axis, the width of each ultrasound image is illustrated along the X-axis, and the number of transmits is illustrated along the Z-axis. The X-axis also represents the direction of the azimuth corresponding to the ultrasound images.

In conventional compounding, a compounded image can be generated (e.g., by an algorithm) by averaging a fixed set of weights corresponding to ultrasound images generated by an ultrasound device. The fixed set of weights applicable to the respective ultrasound images comprised can be stored in system memory, and an algorithm can average respective weights comprised in the fixed set of weights to generate the compounded image. On the contrary, the various embodiments herein can learn respective weights for respective ultrasound images comprised in a set of transmits and apply the respective weights in a convolutional manner, similar to filtering, to generate a compounded image. For example, as discussed with reference to FIG. 1, the various embodiments herein can employ a neural network architecture, as opposed to employing linear compounding, to learn the respective weights for the respective ultrasound images. Doing so can generate a non-linear compounding model (e.g., neural network model 204) that can generate a compounded image with similar image quality to that generated via linear compounding, but with fewer transmits than those employed in linear compounding. As a result, a compounding operator (e.g., model 108) can be employed to predict a set of new transmits and to generate a compounded image, instead employing a different compounding operator to generate the compounded image.

As illustrated by non-limiting image set 1400, conventional coherent compounding is achieved by averaging ultrasound images acquired with a beam steered at different angles. Non-limiting image 1410, non-limiting image 1420, non-limiting image 1430 and non-limiting image 1440 illustrate compounded images with increased contrast in an artery lumen (see arrows) with increasing numbers of ultrasound images employed to generate the respective compounded images, from non-limiting image 1410 to non-limiting image 1440. That is, increasing the number of ultrasound images employed for compounding also increases the contrast in the compounded image, as evident from non-limiting images 1410-1440. Each of non-limiting images 1410-1440 was generated at a different steering angle.

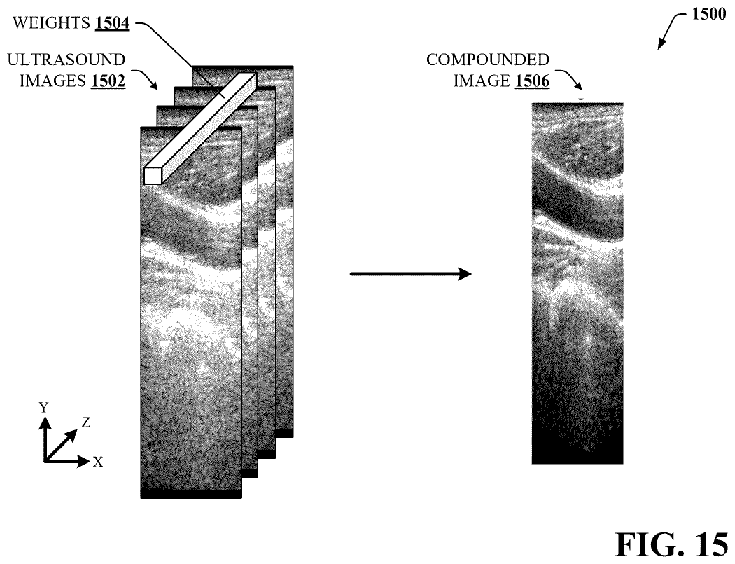

FIG. 15 illustrates a flow diagram of an example, non-limiting method 1500 that shows a reformulation of the conventional approach to linear compounding.

With continued reference to FIG. 14, ultrasound images 1502 can represent a set of ultrasound images that can be compounded to generate compounded image 1506. Weights 1504 can represent a fixed set of weights that can be applied to ultrasound images 1502 in the conventional compounding approach to generate compounded image 1506. Mathematically, ultrasound images 1502 can be represented as TT, compounded image 1506 can be represented as Tₐ, and weights 1504 can be represented as w. Conventional compounding techniques can filter ultrasound images 1502 with fixed weights (at each pixel). This process can be equivalent to applying convolution with a filter with fixed weights. The relationship between TT and Ta can be given by Equation 5. Equation 5 gives the weighting of respective ultrasound images comprised in ultrasound images 1502 that can be employed in a conventional approach to linear compounding to generate compounded image 1506.

Equation 5: wT_{T}(i,j)=T_{α}(i,j) or T_{α}(i,j)=w_{T}(i,j), wherein (i,j) represent a fixed point in space (azimuth, depth) and w is a fixed set of weights. Additionally, w is translated as a raster scan over the tensor of transmits at varying angles T_{α}(data volume(depth×azimuth×transmits)), and the result at each point is the target tensor (image) T_{T}.

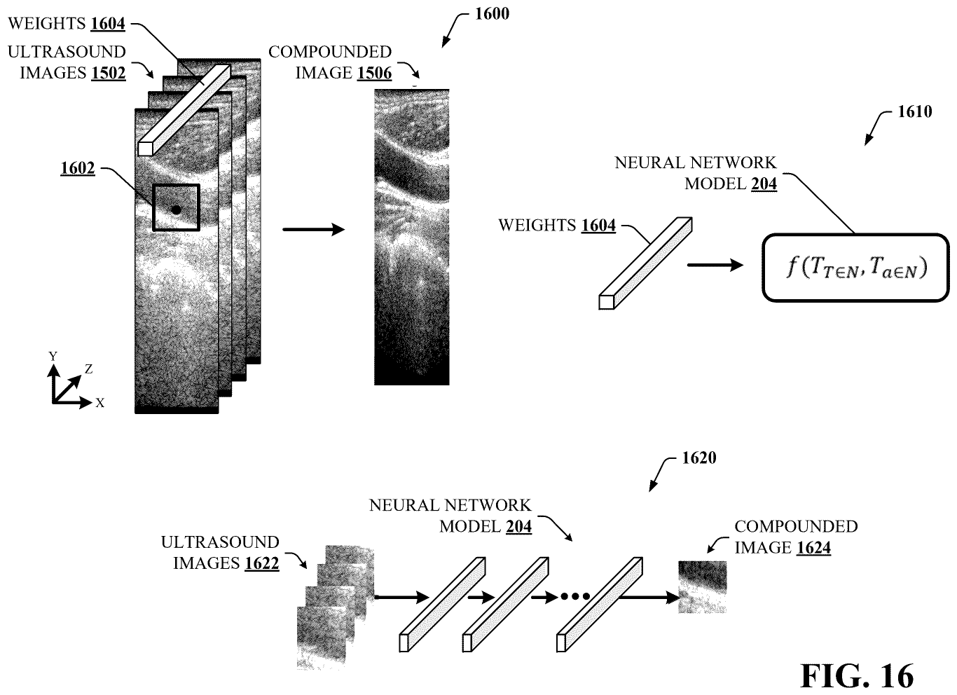

On the contrary, the various embodiments herein can predict a set of weights for ultrasound images 1502 to generate compounded image 1506, as described with reference to FIG. 16.

FIG. 16 illustrates flow diagrams of example, non-limiting methods 1600, 1610 and 1620 that can employ a neural network model to compound ultrasound images in accordance with one or more embodiments described herein. Repetitive description of like elements and/or processes employed in respective embodiments is omitted for sake of brevity.

With continued reference to at least FIGS. 1, 2 and 15, non-limiting methods 1600, 1610 and 1620 illustrate processes that can be employed by neural network model 204 to generate compounded image 1506 by applying weight prediction function 205 to ultrasound images 1502. For example, in one or more embodiments, neural network model 204 can apply weight prediction function 205 to ultrasound images 1502 to predict respective weights for respective ultrasound images comprised in ultrasound images 1502. In non-limiting method 1600, weights 1604 can represent the respective weights predicted by neural network model 204 for ultrasound images 1502. Thereafter, neural network model 204 can employ image generation component 206 to perform weighted averaging/compounding of ultrasound images 1502 to generate compounded image 1506, based on weights 1604. In this regard, ultrasound images 1502 can be analogous to set of ultrasound images 122, and compounded image 1506 can be analogous to compounded image 120.

As discussed with reference to FIG. 1, neural network model 204 can be trained by training component 110 to learn a fixed set of weights, w, for ultrasound images from training data 114. Based on the learned weights, neural network model 204 can learn weight prediction function 205. Thereafter, neural network model 204 can be employed to generate a compounded image based on a new set of ultrasound images such as, for example, ultrasound images 1502, wherein neural network model 204 can employ weight prediction function 205 to predict respective weights for respective ultrasound images comprised in ultrasound images 1502. In the various embodiments herein, during the process of compounding ultrasound images 1502 via neural network model 204, the fixed set of weights, w, applicable to ultrasound images 1502 can become replaced by neural network model 204 to generate compounded image 1506. More specifically, in the various embodiments herein, w, can become a function (e.g., weight prediction function 205) that can best approximate how data from ultrasound images 1502 can be coherently compounded (Equation 6) to achieve an image quality for compounded image 1506 that can be similar to the image quality achieved for a compounded image generated via conventional compounding techniques. As such, in one or more embodiments herein, w can be replaced by neural network model 204, as illustrated by non-limiting method 1610.

Equation 6: w=f(T_{T∈N}, T_{α∈N}), where N denotes a spatial neighborhood around co-ordinates (i, j). In non-limiting method 1600, the symbol at 1602 represents the spatial neighbourhood, N. The function f(T_{T∈N}, T_{α∈N}) can represent weight prediction function 205 that can be learned by neural network model 204 from training data 114 by employing suitable machine learning techniques.

In one or more embodiments, neural network model 204 can function as a composition of functions represented by multiple layers Lᵢ to generate compounded image 1624 from ultrasound images 1622 or to generate compounded image 1506 from ultrasound images 1502, as illustrated by non-limiting method 1620 and given by Equation 7.

Equation 7: T_{α}=L₁\textcircled{*}L₂\textcircled{*}L₃ . . . (TT) where \textcircled{*} denotes convolution in the spatial domain. Equation 7 represents the neural network architecture of neural network model 204, wherein neural network model 204 can be a composition of several layers of neural networks. By replacing the fixed set of weights, w, with neural network model 204, the weight vector, w, can be parameterized as the composition of the layers Lᵢ.

With continued reference to FIGS. 1, 2, and 13-16, FIGS. 17-28 illustrate different results generated by employing neural network model 204 to compound ultrasound images in accordance with the various embodiments herein.

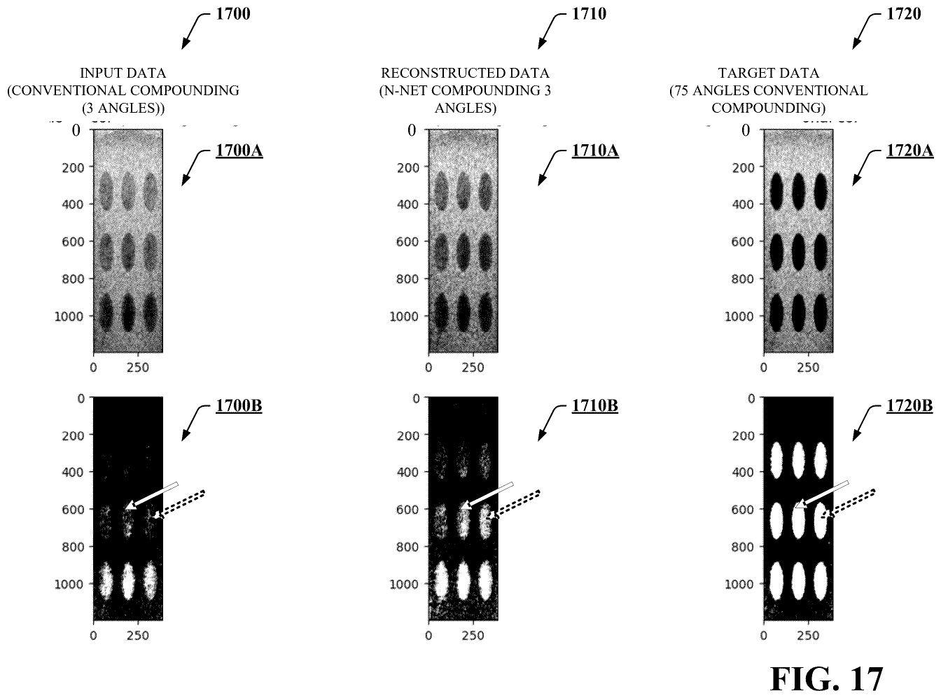

FIG. 17 illustrates example, non-limiting image sets 1700, 1710 and 1720 that show comparisons between results generated by conventional compounding and results generated by a neural network model in accordance with one or more embodiments described herein. Repetitive description of like elements and/or processes employed in respective embodiments is omitted for sake of brevity.

In non-limiting image sets 1700, 1710 and 1720, conventional compounding is compared to compounding via a trained neural network (N-Net), such as neural network model 204, on simulated data in Field II. The images in FIG. 17 (and/or other images in other figures herein) are displayed on a 50 dB dynamic range. Images 1700B, 1710B and 1720B highlight regions of the respective compounded images that are below negative (−) 40 dB relative to the maximum. In images 1700B, 1710B and 1720B, the arrows in the dashed outlines indicate near-field data and the arrows in the solid outlines indicate far-field data.

Images 1700A and 1700B illustrate respective compounded images generated via conventional compounding of three ultrasound images, and images 1710A and 1710B illustrate respective compounded images generated via neural network model 204 from three ultrasound images. Images 1720A and 1720B illustrate respective compounded images generated via conventional compounding of seventy-five ultrasound images. Image 1720A acts as a reference or target for images 1700A and 1710A, and images 1720B acts as a reference or target for images 1700B and 1710B. Evidently, employing neural network model 204 can generate compounded images with similar image quality to that of a compounded image generated by conventional compounding techniques. Although the results of neural network model 204 (images 1710A and 1710B) are not identical to the respective target data (images 1720A and 1720B), it can be observed that the area under −40 dB in the cysts is larger in image 1710B as compared to that in image 1700B (see arrows), which is reinforced by images 1700A, 1710A and 1720B. The results in FIG. 17 can further suggest that trained compounding via neural network model 204 can achieve better contrast in comparison to conventional compounding.

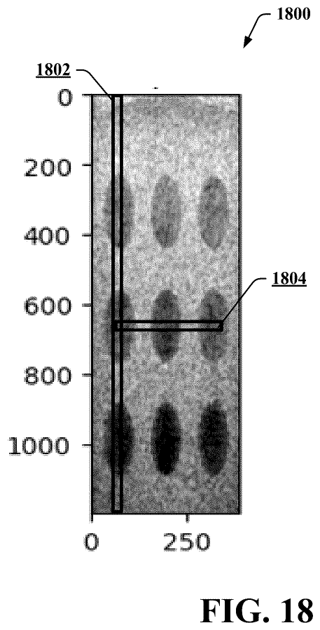

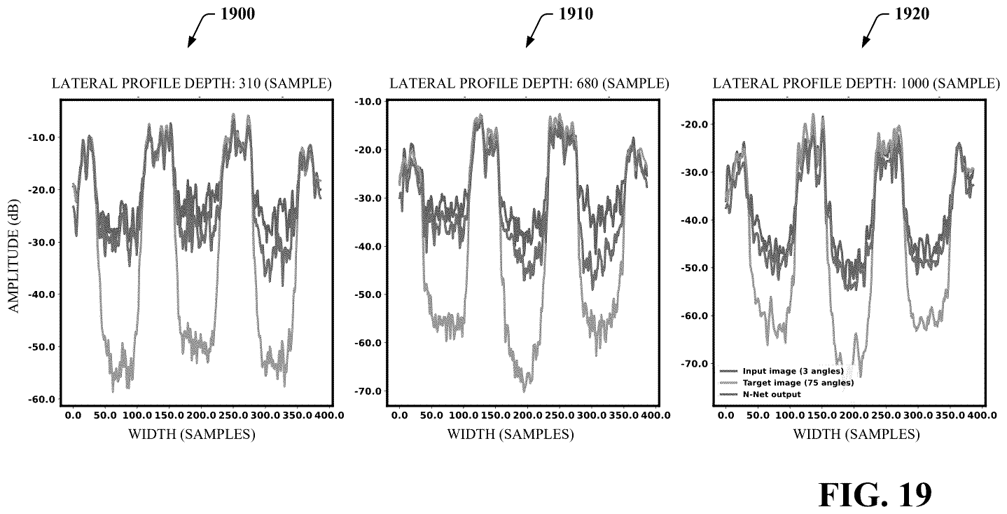

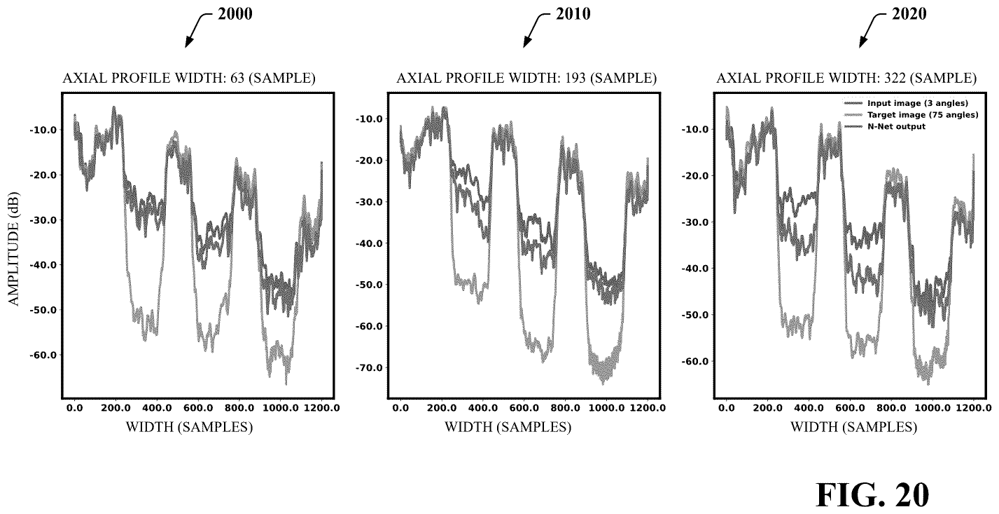

FIG. 18 illustrates an example, non-limiting image 1800 showing a cyst phantom in accordance with one or more embodiments described herein. Repetitive description of like elements and/or processes employed in respective embodiments is omitted for sake of brevity. The cyst phantom illustrated by non-limiting image 1800 was employed to generate the lateral contrast profiles illustrated in FIG. 19 and the axial contrast profiles in FIG. 20. The dark spots in non-limiting image 1800 represent individual cysts in the cyst phantom. Each horizontal row of cysts in the cyst phantom corresponds to a graph in FIG. 19, whereas each vertical row of cysts in the cyst phantom corresponds to a graph in FIG. 20. For example, non-limiting graph 1910 was generated at the lateral location illustrated by strip 1804 in the cyst phantom and corresponds to a horizontal cross section across the first row of cysts in non-limiting image 1800. Similarly, non-limiting graph 2000 was generated at the axial location illustrated by strip 1802 in the cyst phantom and corresponds to a vertical cross section across the leftmost column of cysts in non-limiting image 1800.

With continued reference to FIG. 18, FIG. 19 illustrates example, non-limiting graphs 1900, 1910 and 1920 showing lateral contrast profiles based on a cyst phantom in accordance with one or more embodiments described herein, and FIG. 20 illustrates example, non-limiting graphs 2000, 2010 and 2020 showing axial contrast profiles based on a cyst phantom in accordance with one or more embodiments described herein. Repetitive description of like elements and/or processes employed in respective embodiments is omitted for sake of brevity.

The lateral contrast profiles illustrated by non-limiting graphs 1900, 1910 and 1920 were obtained for the cyst phantom of FIG. 18 at three lateral locations (310, 680 and 1000 sample(s) respectively). For example, beginning at the top of the cyst phantom illustrated in FIG. 18, non-limiting graph 1900 corresponds to the topmost row of cysts, non-limiting graph 1910 corresponds to the middle row of cysts, and non-limiting graph 1920 corresponds to the bottommost row of cysts. Similarly, the axial contrast profiles illustrated by non-limiting graphs 2000, 2010 and 2020 were obtained for the cyst phantom of FIG. 18 at three lateral locations (63, 193 and 322 sample(s) respectively). For example, beginning at the left-hand side of the cyst phantom illustrated in FIG. 18, non-limiting graph 2000 corresponds to the leftmost column of cysts, non-limiting graph 2010 corresponds to the middle column of cysts, and non-limiting graph 2020 corresponds to the rightmost column of cysts.

In non-limiting graphs 1900, 1910, 1920, 2000, 2010 and 2020, the blue plot lines represent contrast profiles corresponding to compounded images generated by conventional compounding of three ultrasound images, the green plot lines represent contrast profiles corresponding to compounded images generated by neural network model 204 from three ultrasound images, and the orange plot lines represent contrast profiles corresponding to compounded images generated by conventional compounding of seventy-five ultrasound images. The orange plot lines serve as a reference/target for the blue and green plot lines, in each graph, similar to the results in FIG. 17. The results from FIGS. 19 and 20 illustrate that while neural network model 204 pushes the cyst echogenicity down, it may not always reach the threshold of −40 dB with one application.

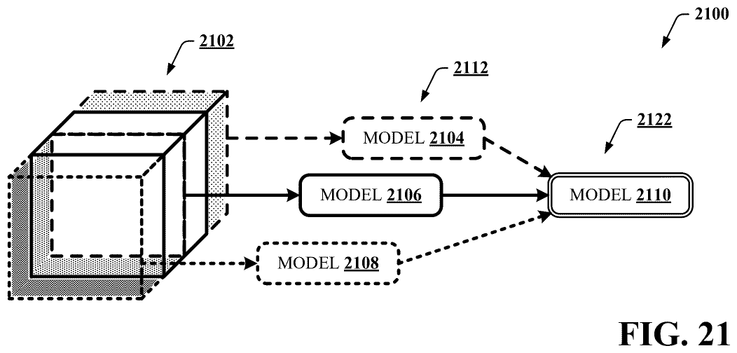

FIG. 21 illustrates a diagram of an example, non-limiting multi-stage model 2100 that can generate a compounded image from ultrasound images in accordance with one or more embodiments described herein. Repetitive description of like elements and/or processes employed in respective embodiments is omitted for sake of brevity.

As discussed with reference to FIG. 1, in one or more embodiments, neural network model 204 can be employed in a multi-stage model that can generate compounded images (e.g., compounded image 120) from ultrasound images (e.g., set of ultrasound images 122) via a cascading approach. For example, an overlapping sliding queue (or sliding blocks) of data corresponding to respective ultrasound images comprised in set of ultrasound images 122 can be input into/accessed by a plurality of models to generate an output. Thereafter, the output can be input into/accessed by neural network model 204 to generate compounded image 120. In an embodiment, the plurality of models can be identical to or different from neural network model 204. The cascading approach can increase contrast in compounded image 120. Additionally, in one or more embodiments, employing the overlapping sliding queue of data can increase a frame rate associated with compounded image 120.

In ultrasound imaging, the beams (sound waves) are usually steered symmetrically at positive (+) 5°, 0° and negative (−) 5° degrees of angulation with respect to the normal. If the ultrasound images are generated without any overlap of the beams, the corresponding frame rate drops even further because all the ultrasound images need to be acquired during each scan. However, if the scanning is done with an overlap of the beams, data from a scan can be reused for another scan. This concept can be applied to neural network model 204 to generate the multi-stage model, wherein the output of a model can be cascaded multiple times. In one or more embodiments, the multi-stage model can be generated by training component 110, wherein training component 110 can train individual models comprised in the multi-stage model. In this regard, non-limiting multi-stage model 2100 illustrates a two-stage model that can be employed to generate compounded image 120 from set of ultrasound images 122. In some embodiments, non-limiting multi-stage model 2100 can have more than two stages. For example, in some embodiments, the frame rate can be adjustable by employing multiple models in subsequent cascades, consequently achieving a trade-off between image quality and frame rate.

In non-limiting multi-stage model 2100, stage 2112 and stage 2122 can correspond to the same model (e.g., neural network model 204) or different models. For example, in an embodiment, model 2104, model 2106, model 2108 and model 2110 can be identical to neural network model 204 in terms of model type and model architecture, whereas in another embodiment, model 2104, model 2106, and model 2108 can be different from neural network model 204 in terms of model type and architecture, and model 2110 can be identical to neural network model. Any suitable combinations of model types and model architectures can be employed by non-limiting multi-stage model 2100. Models 2104, 2106 and 2108 of non-limiting multi-stage model 2100 can access input 2102 comprising a sliding queue of data (denoted by different lines/patterns) of ultrasound images. The outputs generated by models 2104, 2106 and 2108 can be first compounded images. The first compounded images can be further accessed by model 2110 to enhance the effect and image quality of a second compounded image that can be generated by model 2110 based on the first compounded images. In this regard, non-limiting multi-stage model 2100 illustrates an exemplary model wherein the output of one or more models can be cascaded to the same model or to a different model.

Employing the sliding queue with overlap can ensure a larger gain in the frame rate to achieve similar effects. For example, given nine ultrasound images (transmits/frames/angles) in a sequence, the training data tensor, T_{T}, in conventional compounding can be ultrasound images 1-3, and the target tensor Tα can be the result generated by compounding all nine ultrasound images via conventional compounding. Without any overlap in the ultrasound images, employing ultrasound images (1, 2, 3), (4, 5, 6), and (7, 8, 9) results in no gain in frame rate (i.e., nine transmits are compounded). However, with an overlapping scheme (sliding queue of data) comprising ultrasound images (1, 2, 3), (2, 3, 4), (3, 4, 5), such as employed by embodiments of the present disclosure, a similar effect/image quality can be achieved for the compounded image with only five transmits (i.e., as opposed to nine transmits). For example, model 2104 can ingest ultrasound images (1, 2, 3), model 2106 can ingest ultrasound images (2, 3, 4) and model 2106 can ingest ultrasound images (3, 4, 5) to generate an output that can be further processed by model 2110 to generate a compounded image.

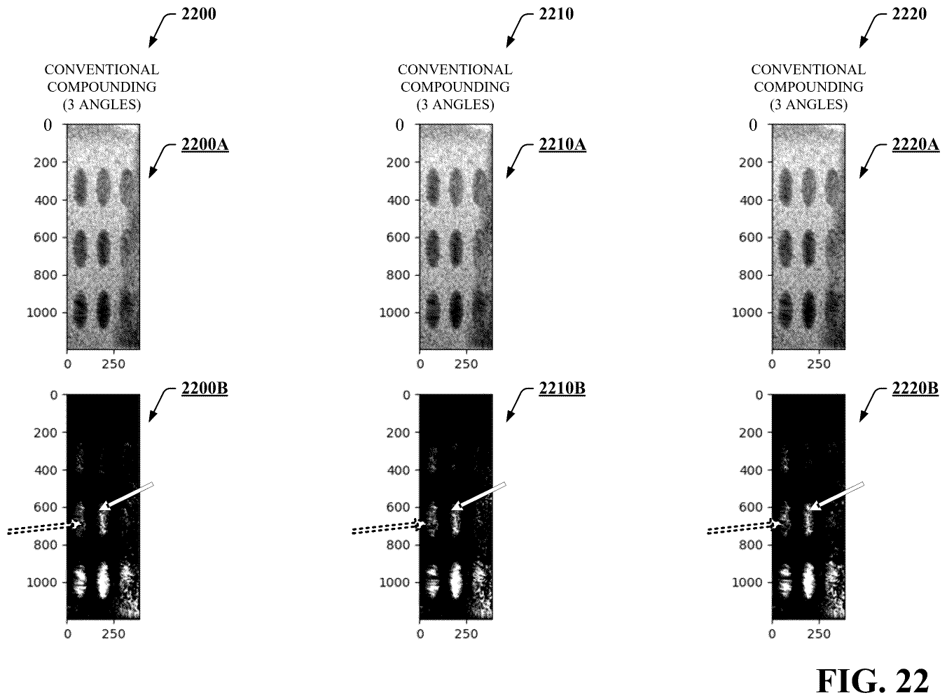

With continued reference to at least FIG. 21, FIGS. 22-28 illustrate qualitative results based on the one or more embodiments disclosed.

FIG. 22 illustrates example, non-limiting image sets 2200, 2210 and 2220 that show stagewise results based on conventional compounding.

Non-limiting image sets 2200, 2210 and 2220 demonstrate compounded images generated via conventional compounding on simulated data in Field II. Non-limiting image sets 2200, 2210 and 2220 illustrate stagewise results for (inputs, angles (1, 2, 3), (2, 3, 4), (3, 4, 5)). Image 2200A, image 2210A and image 2220A demonstrate compounded images generated via conventional compounding with transmits (1, 2, 3), (2, 3, 4), and (3, 4, 5), respectively. Image 2200B demonstrates a compounded image generated via conventional compounding with transmits (1, 2, 3), image 2210B demonstrates a compounded image generated via conventional compounding with transmits (2, 3, 4), and image 2220B demonstrates a compounded image generated via conventional compounding with transmits (3, 4, 5). Additionally, images 2200B, 2210B and 2220B highlight regions of the respective compounded images that are below negative (−) 40 dB relative to the maximum (see arrows). In FIG. 22, the arrows in the dashed outlines indicate near-field data and the arrows in the solid outlines indicate far-field data.

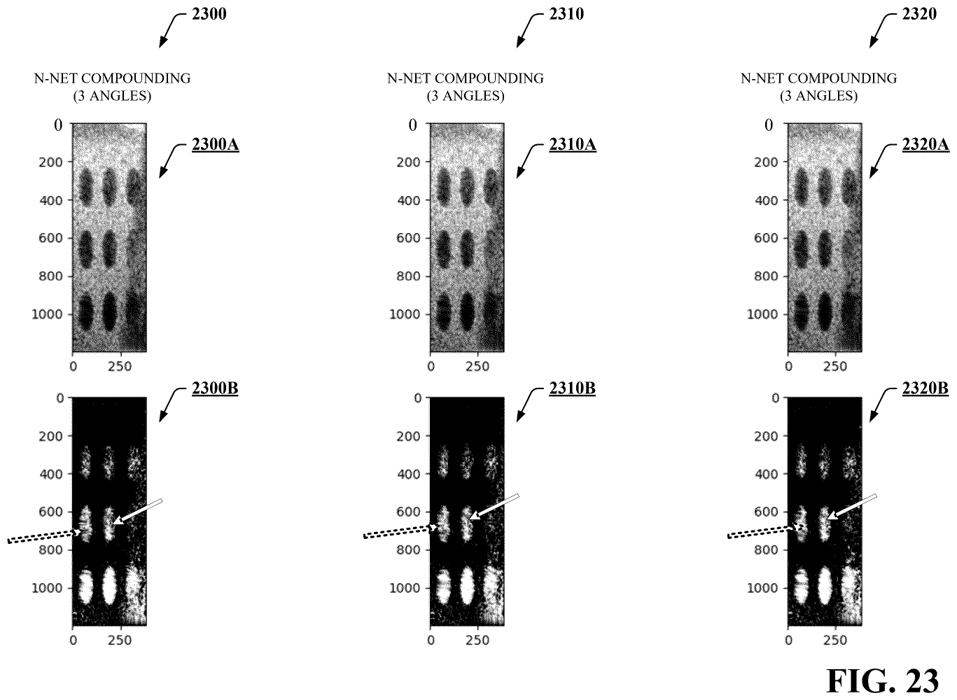

FIG. 23 illustrates example, non-limiting image sets 2300, 2310 and 2320 that show outputs generated by an intermediate stage of a multi-stage model in accordance with one or more embodiments described herein. Repetitive description of like elements and/or processes employed in respective embodiments is omitted for sake of brevity.

Images 2300A, 2300B, 2310A, 2310B, 2320A and 2320B illustrate compounded images generated at stage 2112 of non-limiting multi-stage model 2100 based on a sliding queue of data, wherein non-limiting multi-stage model 2100 can be a trained multi-stage neural network model. Images 2300A, 2310A and 2320A demonstrate compounded images generated via conventional compounding with transmits (1, 2, 3), (2, 3, 4), and (3, 4, 5) respectively. Image 2300B demonstrates a compounded image generated via conventional compounding with transmits (1, 2, 3), image 2310B demonstrates a compounded image generated via conventional compounding with transmits (2, 3, 4), and image 2220B demonstrates a compounded image generated via conventional compounding with transmits (3, 4, 5). Additionally, images 2300B, 2310B and 2320B highlight regions of the respective compounded images that are below negative (−) 40 dB relative to the maximum (see arrows). In FIG. 23, the arrows in the dashed outlines indicate near-field data and the arrows in the solid outlines indicate far-field data.

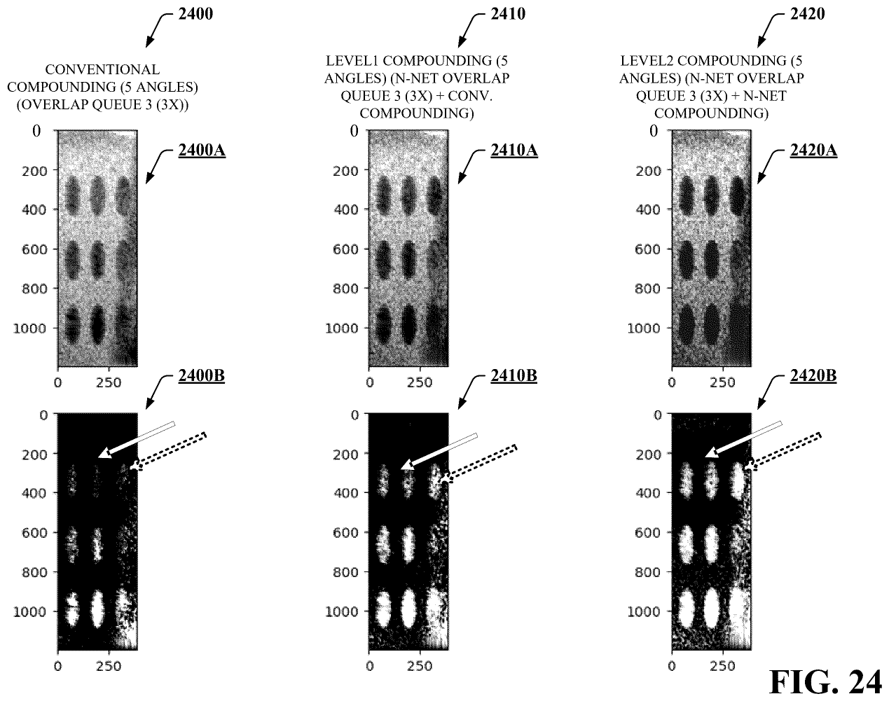

It can be observed that images 2300B, 2310B and 2320B show an increased contrast as compared to images 2300A, 2310A and 2320A, with the cysts visible more sharply (a larger area of anechoic cysts was pushed below the negative (−) 40 dB limit in images 2300B, 2310B and 2320B). FIG. 24 illustrates an output of stage 2122 of non-limiting multi-stage model 2100.

FIG. 24 illustrates example, non-limiting image sets 2400, 2410 and 2420 that show outputs generated by a second stage of a multi-stage model in accordance with one or more embodiments described herein. Repetitive description of like elements and/or processes employed in respective embodiments is omitted for sake of brevity.

Images 2400A, 2410A and 2420A illustrate compounded images generated at a first stage of non-limiting multi-stage model 2100. Images 2400B, 2410B, and 2420B illustrate compounded images generated at a second stage of non-limiting multi-stage model 2100 based on an output (i.e., images 2400A, 2410A and 2420A) generated by the first stage of the multi-stage model. That is, to generate images 2400B, 2410B, and 2420B, images 2400A, 2410A and 2420A were fed back to non-limiting multi-stage model 2100. Images 2400B, 2410B, and 2420B illustrate the gains in contrast as a result of employing non-limiting multi-stage model 2100 twice. Image 2410B illustrates the contrast in a compounded image generated with a single application of non-limiting multi-stage model 2100, that is, if conventional compounding was employed instead of stage 2122 of non-limiting multi-stage model 2100.

Similar to the results presented in FIG. 23, it can be observed that images 2400B, 2410B and 2420B show an increased contrast as compared to images 2400A, 2410A and 2420A, with the cysts visible more sharply (a larger area of anechoic cysts was pushed below the negative (−) 40 dB limit in images 2300B, 2310B and 2320B).

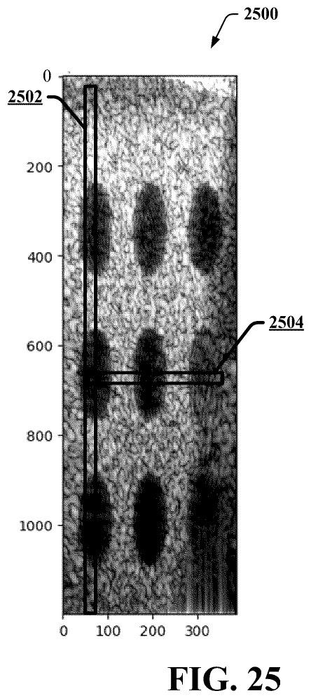

FIG. 25 illustrates an example, non-limiting image 2500 showing a cyst phantom in accordance with one or more embodiments described herein. Repetitive description of like elements and/or processes employed in respective embodiments is omitted for sake of brevity.

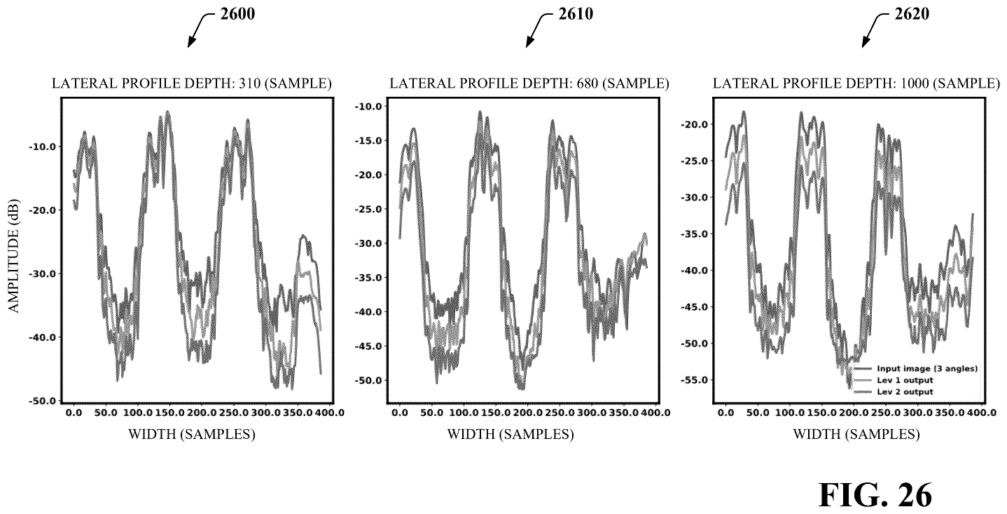

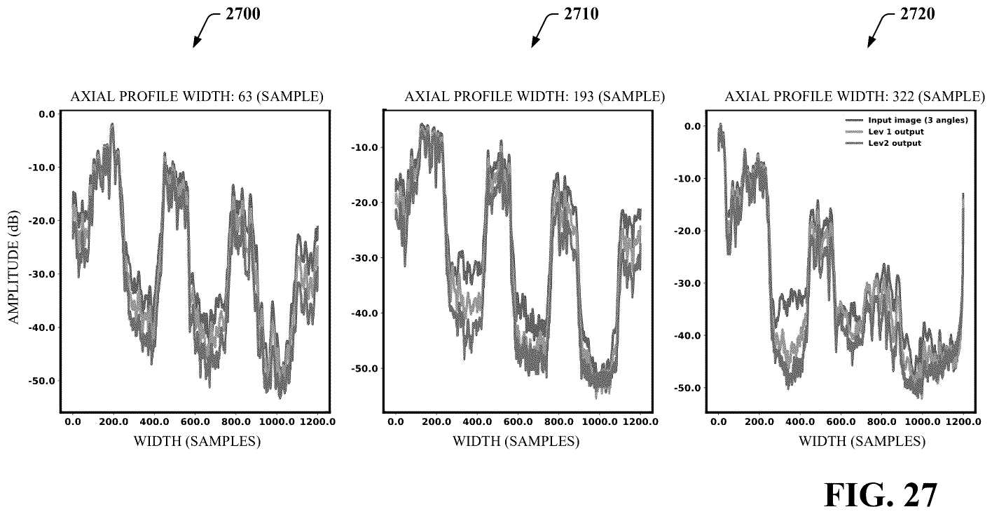

The cyst phantom illustrated by non-limiting image 2500 was employed to generate the lateral contrast profiles illustrated in FIG. 26 and the axial contrast profiles in FIG. 27. The dark spots in non-limiting image 2500 represent individual cysts in the cyst phantom. Each horizontal row of cysts in the cyst phantom corresponds to a graph in FIG. 26, whereas each vertical row of cysts in the cyst phantom corresponds to a graph in FIG. 27. For example, non-limiting graph 2610 was generated at the lateral location illustrated by strip 2504 in the cyst phantom and corresponds to a horizontal cross section across the middle row of cysts in non-limiting image 2500. Similarly, non-limiting graph 2700 was generated at the axial location illustrated by strip 2502 in the cyst phantom and corresponds to a vertical cross section across the leftmost column of cysts in non-limiting image 2500.

With continued reference to FIG. 25, FIG. 26 illustrates example, non-limiting graphs 2600, 2610 and 2620 showing lateral contrast profiles based on a cyst phantom in accordance with one or more embodiments described herein, and FIG. 27 illustrates example, non-limiting graphs 2700, 2710 and 2720 showing axial contrast profiles based on a cyst phantom in accordance with one or more embodiments described herein. Repetitive description of like elements and/or processes employed in respective embodiments is omitted for sake of brevity.

Non-limiting graphs 2600, 2610 and 2620 illustrate results of a two-level validation. In the experiments conducted in relation to the various embodiments herein, the two-level application (i.e., two stages of non-limiting multi-stage model 2100) was validated on the cyst phantom illustrated by non-limiting image 2500 for three different angles. In this regard, non-limiting graphs 2600, 2610 and 2620 depict the contrast in the lateral direction across the cysts illustrated in the cyst phantom of FIG. 25, and non-limiting graphs 2700, 2710 and 2720 depict the contrast in the axial direction across the cysts illustrated in the cyst phantom of FIG. 25.

The respective lateral contrast profiles illustrated by non-limiting graphs 2600, 2610 and 2620 were obtained for the cyst phantom at three lateral locations (310, 680 and 1000 sample(s) respectively). For example, beginning at the top of the cyst phantom illustrated in FIG. 25, non-limiting graph 2600 corresponds to the topmost row of cysts, non-limiting graph 2610 corresponds to the middle row of cysts, and non-limiting graph 2620 corresponds to the bottommost row of cysts. Similarly, the respective axial contrast profiles illustrated by non-limiting graphs 2700, 2710 and 2720 were obtained for the cyst phantom at three axial locations (63, 193 and 322 sample(s) respectively). For example, beginning at the left-hand side of the cyst phantom illustrated in FIG. 25, non-limiting graph 2700 corresponds to the leftmost column of cysts, non-limiting graph 2710 corresponds to the middle column of cysts, and non-limiting graph 2720 corresponds to the rightmost column of cysts.

In each of non-limiting graphs 2600, 2610, 2620, 2700, 2710 and 2720, the blue plot lines represent contrast profiles corresponding to compounded images generated by conventional compounding of three ultrasound images, the orange plot lines represent a level 1/stage 1 output of non-limiting multi-stage model 2100, and the green plot lines represent a level 2/stage 2 output of non-limiting multi-stage model 2100.

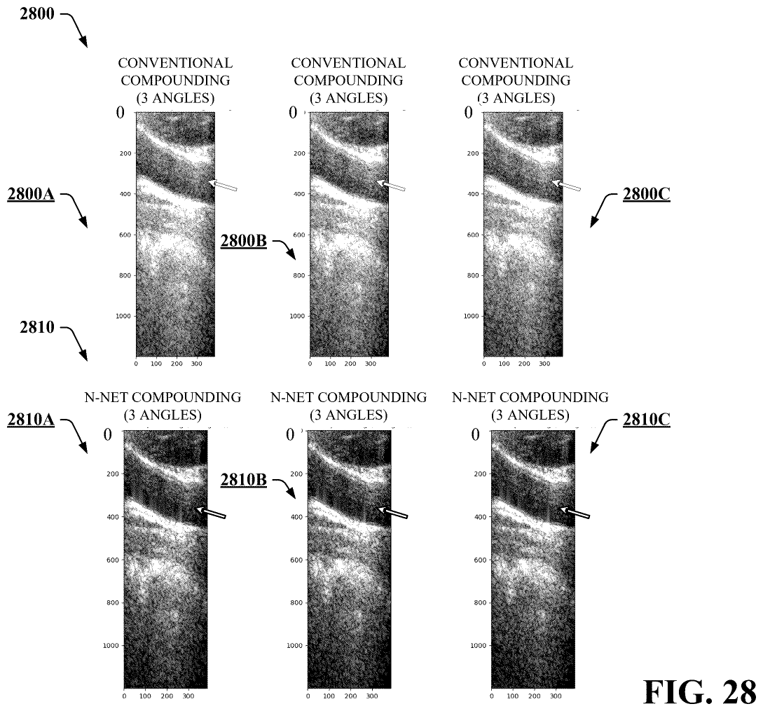

FIG. 28 illustrates example, non-limiting image sets 2800 and 2810 that show in vivo results based on test data in accordance with one or more embodiments described herein. Repetitive description of like elements and/or processes employed in respective embodiments is omitted for sake of brevity.

Non-limiting image set 2800 shows in vivo results generated via conventional compounding of three ultrasound images. Non-limiting image set 2810 shows in vivo results generated by non-limiting multi-stage model 2100 from three ultrasound images, after training non-limiting multi-stage model 2100 on simulated field II data. The input, in each case, was in vivo data (ultrasound images of a carotid artery long cross section).

Images 2810A, 2810B and 2810C illustrate the gains in contrast as compared to the corresponding images 2800A, 2800B and 2800C. For example, it can be observed that images 2810A, 2810B and 2810C show increased contrast in the vessel lumen (see arrows).

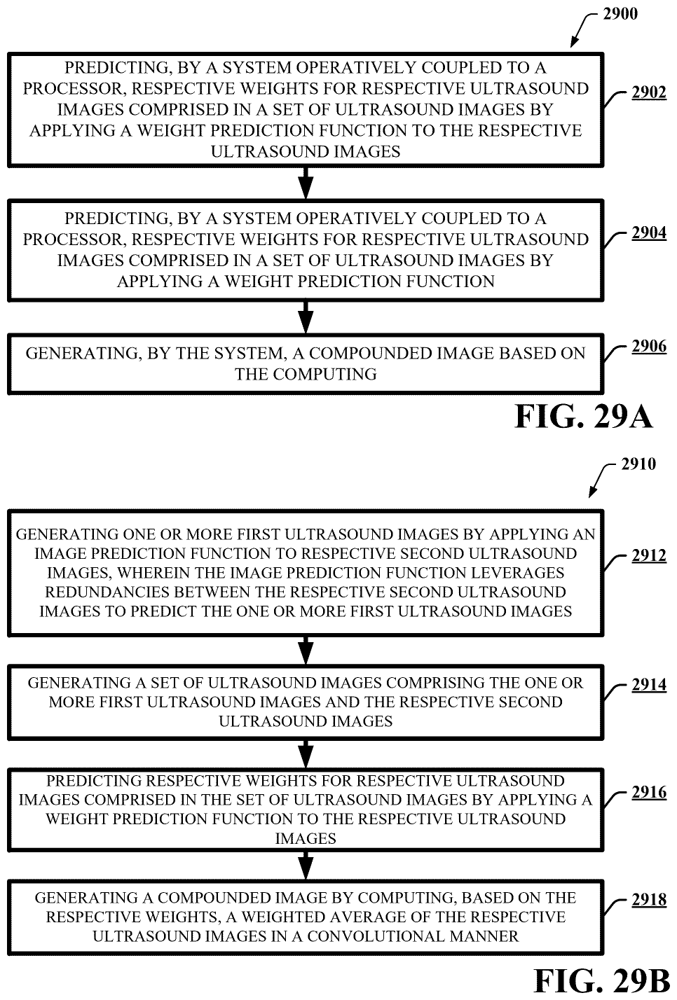

FIG. 29A illustrates a flow diagram of an example, non-limiting method 2900 that can be employed to generate a compounded image by applying a weight prediction function to ultrasound images in accordance with one or more embodiments described herein. Repetitive description of like elements and/or processes employed in respective embodiments is omitted for sake of brevity.

At 2902, non-limiting method 2900 can comprise predicting (e.g., by neural network model 204), by a system operatively coupled to a processor, respective weights for respective ultrasound images comprised in a set of ultrasound images by applying a weight prediction function (e.g., weight prediction function 205) to the respective ultrasound images.

At 2904, non-limiting method 2900 can comprise computing (e.g., by image generation component 206 of neural network model 204), by the system, based on the respective weights, a weighted average of the respective ultrasound images in a convolutional manner.

At 2906, non-limiting method 2900 can comprise generating (e.g., by image generation component 206 of neural network model 204), by the system, a compounded image based on the computing.

FIG. 29B illustrates a flow diagram of an example, non-limiting method 2910 that can be employed to generate a compounded image by applying an image prediction function to predict new ultrasound images and a weight prediction function to compound ultrasound images in accordance with one or more embodiments described herein. Repetitive description of like elements and/or processes employed in respective embodiments is omitted for sake of brevity.

At 2912, non-limiting method 2910 can comprise generating (e.g., by neural network model 202) one or more first ultrasound images by applying an image prediction function (e.g., image prediction function 203) to respective second ultrasound images, wherein the image prediction function leverages redundancies between the respective second ultrasound images to predict the one or more first ultrasound images.

At 2914, non-limiting method 2910 can comprise generating (e.g., by neural network model 202) a set of ultrasound images comprising the one or more first ultrasound images and the respective second ultrasound images.

At 2916, non-limiting method 2910 can comprise predicting (e.g., by neural network model 204) respective weights for respective ultrasound images comprised in the set of ultrasound images by applying a weight prediction function (e.g., weight prediction function 205) to the respective ultrasound images.

At 2918, non-limiting method 2910 can comprise generating (e.g., by image generation component 206 of neural network model 204) a compounded image by computing, based on the respective weights, a weighted average of the respective ultrasound images in a convolutional manner.

For simplicity of explanation, the computer-implemented and non-computer-implemented methodologies provided herein are depicted and/or described as a series of acts. It is to be understood that the subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented and non-computer-implemented methodologies in accordance with the described subject matter. Additionally, the computer-implemented methodologies described hereinafter and throughout this specification are capable of being stored on an article of manufacture to enable transporting and transferring the computer-implemented methodologies to computers. The term article of manufacture, as used herein, is intended to encompass a computer program accessible from any computer-readable device or storage media.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

### Example Operating Environment

One or more embodiments can be a system, a method, and/or a computer program product at any possible technical detail level of integration. The computer program product can include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It can be understood that each block of the flowchart illustrations and/or block diagrams, and combinations of blocks in the flowchart illustrations and/or block diagrams, can be implemented by computer readable program instructions.

These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession may, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

In connection with FIG. 30, the systems and processes described below can be embodied within hardware, such as a single integrated circuit (IC) chip, multiple ICs, an application specific integrated circuit (ASIC), or the like. Further, the order in which some or all of the process blocks appear in each process should not be deemed limiting. Rather, it should be understood that some of the process blocks can be executed in a variety of orders, not all of which can be explicitly illustrated herein.

With reference to FIG. 30, an example environment 3000 for implementing various aspects of the claimed subject matter includes a computer 3002. The computer 3002 includes a processing unit 3004, a system memory 3006, a codec 3035, and a system bus 3008. The system bus 3008 couples system components including, but not limited to, the system memory 3006 to the processing unit 3004. The processing unit 3004 can be any of various available processors. Dual microprocessors and other multiprocessor architectures also can be employed as the processing unit 3004.

The system bus 3008 can be any of several types of bus structure(s) including the memory bus or memory controller, a peripheral bus or external bus, or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1294), and Small Computer Systems Interface (SCSI).

The system memory 3006 includes volatile memory 3010 and non-volatile memory 3012, which can employ one or more of the disclosed memory architectures, in various embodiments. The basic input/output system (BIOS), containing the basic routines to transfer information between elements within the computer 3002, such as during start-up, is stored in non-volatile memory 3012. In addition, according to present innovations, codec 3035 can include at least one of an encoder or decoder, wherein the at least one of an encoder or decoder can consist of hardware, software, or a combination of hardware and software. Although, codec 3035 is depicted as a separate component, codec 3035 can be contained within non-volatile memory 3012. By way of illustration, and not limitation, non-volatile memory 3012 can include read only memory (ROM), programmable ROM (PROM), electrically programmable ROM (EPROM), electrically erasable programmable ROM (EEPROM), Flash memory, 3D Flash memory, or resistive memory such as resistive random access memory (RRAM). Non-volatile memory 3012 can employ one or more of the disclosed memory devices, in at least some embodiments. Moreover, non-volatile memory 3012 can be computer memory (e.g., physically integrated with computer 3002 or a mainboard thereof), or removable memory. Examples of suitable removable memory with which disclosed embodiments can be implemented can include a secure digital (SD) card, a compact Flash (CF) card, a universal serial bus (USB) memory stick, or the like. Volatile memory 3010 includes random access memory (RAM), which acts as external cache memory, and can also employ one or more disclosed memory devices in various embodiments. By way of illustration and not limitation, RAM is available in many forms such as static RAM (SRAM), dynamic RAM (DRAM), synchronous DRAM (SDRAM), double data rate SDRAM (DDR SDRAM), and enhanced SDRAM (ESDRAM) and so forth.

Computer 3002 can also include removable/non-removable, volatile/non-volatile computer storage medium. FIG. 30 illustrates, for example, disk storage 3014. Disk storage 3014 includes, but is not limited to, devices like a magnetic disk drive, solid state disk (SSD), flash memory card, or memory stick. In addition, disk storage 3014 can include storage medium separately or in combination with other storage medium including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage 3014 to the system bus 3008, a removable or non-removable interface is typically used, such as interface 3016. It is appreciated that disk storage 3014 can store information related to a user. Such information might be stored at or provided to a server or to an application running on a user device. In one embodiment, the user can be notified (e.g., by way of output device(s) 3036) of the types of information that are stored to disk storage 3014 or transmitted to the server or application. The user can be provided the opportunity to opt-in or opt-out of having such information collected or shared with the server or application (e.g., by way of input from input device(s) 3028).

It is to be appreciated that FIG. 30 describes software that acts as an intermediary between users and the basic computer resources described in the suitable operating environment 3000. Such software includes an operating system 3018. Operating system 3018, which can be stored on disk storage 3014, acts to control and allocate resources of the computer 3002. Applications 3020 take advantage of the management of resources by operating system 3018 through program modules 3024, and program data 3026, such as the boot/shutdown transaction table and the like, stored either in system memory 3006 or on disk storage 3014. It is to be appreciated that the claimed subject matter can be implemented with various operating systems or combinations of operating systems.

A user enters commands or information into the computer 3002 through input device(s) 3028. Input devices 3028 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 3004 through the system bus 3008 via interface port(s) 3030. Interface port(s) 3030 include, for example, a serial port, a parallel port, a game port, and a universal serial bus (USB). Output device(s) 3036 use some of the same type of ports as input device(s) 3028. Thus, for example, a USB port can be used to provide input to computer 3002 and to output information from computer 3002 to an output device 3036. Output adapter 3034 is provided to illustrate that there are some output devices 3036 like monitors, speakers, and printers, among other output devices 3036, which require special adapters. The output adapters 3034 include, by way of illustration and not limitation, video and sound cards that provide a means of connection between the output device 3036 and the system bus 3008. It should be noted that other devices or systems of devices provide both input and output capabilities such as remote computer(s) 3038.

Computer 3002 can operate in a networked environment using logical connections to one or more remote computers, such as remote computer(s) 3038. The remote computer(s) 3038 can be a personal computer, a server, a router, a network PC, a workstation, a microprocessor based appliance, a peer device, a smart phone, a tablet, or other network node, and typically includes many of the elements described relative to computer 3002. For purposes of brevity, only a memory storage device 3040 is illustrated with remote computer(s) 3038. Remote computer(s) 3038 is logically connected to computer 3002 through a network interface 3042 and then connected via communication connection(s) 3044. Network interface 3042 encompasses wire or wireless communication networks such as local-area networks (LAN) and wide-area networks (WAN) and cellular networks. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 3044 refers to the hardware/software employed to connect the network interface 3042 to the bus 3008. While communication connection 3044 is shown for illustrative clarity inside computer 3002, it can also be external to computer 3002. The hardware/software necessary for connection to the network interface 3042 includes, for exemplary purposes only, internal and external technologies such as, modems including regular telephone grade modems, cable modems and DSL modems, ISDN adapters, and wired and wireless Ethernet cards, hubs, and routers.

While the subject matter has been described above in the general context of computer executable instructions of a computer program product that runs on a computer and/or computers, those skilled in the art will recognize that this disclosure also can or can be implemented in combination with other program modules. Generally, program modules include routines, programs, components, data structures, etc. that perform particular tasks and/or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments where tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration and are intended to be non-limiting. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim. The descriptions of the various embodiments have been presented for purposes of illustration, but are not intended to be exhaustive or limited to the embodiments disclosed. Many modifications and variations can be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising:
a memory that stores computer executable instructions; and
a processor that executes the computer executable instructions that, when executed by the processor, facilitate performance of operations comprising:
generating one or more first ultrasound images by applying an image prediction function to respective second ultrasound images, wherein the image prediction function leverages redundancies between the respective second ultrasound images to predict the one or more first ultrasound images;
generating a set of ultrasound images comprising the one or more first ultrasound images and the respective second ultrasound images; and
generating a compounded image by computing a weighted average of respective ultrasound images comprised in the set of ultrasound images.

2. The system of claim 1, wherein the operations further comprise:
accessing a first set of training ultrasound images; and
learning the image prediction function by predicting a sequence of training ultrasound images comprised in the first set of training ultrasound images based on a preceding sequence of training ultrasound images comprised in the first set of training ultrasound images.

3. The system of claim 1, wherein the compounded image is a sum of delayed data comprised in the set of ultrasound images.

4. The system of claim 1, wherein data from the respective ultrasound images comprised in the set of ultrasound images is a function of the respective second ultrasound images and a time delay corresponding to the respective second ultrasound images.

5. The system of claim 1, wherein the operations further comprise:
applying the image prediction function after applying beamforming delays to the respective second ultrasound images.

6. The system of claim 1, wherein the operations further comprise:
predicting respective weights for the respective ultrasound images by applying a weight prediction function to generate the compounded image; and
generating the compounded image by computing, based on the respective weights, the weighted average of the respective ultrasound images in a convolutional manner.

7. The system of claim 6, wherein the operations further comprise:
accessing a second set of training ultrasound images; and
learning the weight prediction function by learning respective fixed weights associated with respective training ultrasound images comprised in the second set of training ultrasound images, wherein the learning the fixed weights comprises analyzing contrast present in a training compounded image generated from the second set of training ultrasound images.

8. The system of claim 1, wherein the operations further comprise:
accessing a set of fixed weights associated with the set of ultrasound images; and
generating the compounded image by averaging the set of fixed weights.

9. A computer-implemented method, comprising:
predicting, by a system operatively coupled to a processor, respective weights for respective ultrasound images comprised in a set of ultrasound images by applying a weight prediction function to the respective ultrasound images;
computing, by the system, based on the respective weights, a weighted average of the respective ultrasound images in a convolutional manner; and
generating, by the system, a compounded image based on the computing.

10. The computer-implemented method of claim 9, further comprising:
accessing, by the system, a set of training ultrasound images; and
learning, by the system, the weight prediction function by learning respective fixed weights associated with respective training ultrasound images comprised in the set of training ultrasound images, wherein the learning the fixed weights comprises analyzing contrast present in a training compounded image generated from the set of training ultrasound images.

11. The computer-implemented method of claim 9, wherein the weight prediction function is learned by a neural network model that applies the weight prediction function in lieu of a set of fixed weights associated with the respective ultrasound images.

12. The computer-implemented method of claim 11, wherein a weight vector associated with the set of fixed weights is parametrized as a composition of layers of the neural network model.

13. The computer-implemented method of claim 11, wherein the compounded image is generated by a multi-stage model comprising the neural network model in a cascading approach, and wherein the generating comprises:
inputting, by the system, an overlapping sliding queue of data corresponding to the respective ultrasound images into a plurality of models to generate an output; and
inputting, by the system, the output into the neural network model to generate the compounded image.

14. The computer-implemented method of claim 13, wherein the plurality of models are identical to the neural network model.

15. The computer-implemented method of claim 13, wherein the plurality of models are different from the neural network model.

16. The computer-implemented method of claim 13, wherein the cascading approach increases contrast in the compounded image.

17. The computer-implemented method of claim 13, wherein employing the overlapping sliding queue of data increases a frame rate associated with the compounded image.

18. A computer program product comprising a non-transitory computer readable memory having program instructions embodied therewith, the program instructions executable by a processor to cause the processor to:
generate one or more first ultrasound images by applying an image prediction function to respective second ultrasound images, wherein the image prediction function leverages redundancies between the respective second ultrasound images to predict the one or more first ultrasound images;
generate a set of ultrasound images comprising the one or more first ultrasound images and the respective second ultrasound images;
predict respective weights for respective ultrasound images comprised in the set of ultrasound images by applying a weight prediction function to the respective ultrasound images; and
generate a compounded image by computing, based on the respective weights, a weighted average of the respective ultrasound images in a convolutional manner.

19. The computer program product of claim 18, wherein the program instructions are further executable by the processor to cause the processor to:
access a first set of training ultrasound images; and
learn the image prediction function by predicting a sequence of training ultrasound images comprised in the first set of training ultrasound images based on a preceding sequence of training ultrasound images comprised in the first set of training ultrasound images to.

20. The computer program product of claim 18, wherein the program instructions are further executable by the processor to cause the processor to:
access a second set of training ultrasound images; and
learn the weight prediction function by learning respective fixed weights associated with respective training ultrasound images comprised in the second set of training ultrasound images, wherein the learning the fixed weights comprises analyzing contrast present in a training compounded image generated from the second set of training ultrasound images.
